(19) United States
(12) Patent Application Publication
(10) Pub. No.: US 2010/0259631 A1
(43) Pub. Date: Oct. 14, 2010

(54) DATA COMPRESSION APPARATUS, DATA COMPRESSION PROGRAM AND IMAGE-TAKING APPARATUS

(75) Inventor: Yukio Sugita, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 12/739,647

(22) PCT Filed: Feb. 10, 2008
(86) PCT No.: PCT/JP2008/067955

§ 371 Date: Apr. 23, 2010

(30) Foreign Application Priority Data
Oct. 26, 2007 (JP) 2007-278638
Nov. 2, 2007 (JP) 2007-286513
Nov. 2, 2007 (JP) 2007-286514

(51) Int. Cl. H04N 5/228; G06K 9/36; H04N 7/26

(52) U.S. Cl. 348/222.1; 382/232; 382/246; 348/E05.031

(57) ABSTRACT

In order to provide a data compression apparatus, a data compression program and an image-taking apparatus estimating the compression ratio and being adequate for reducing an operation time, a differential generation section that determines, for a series of numerical values of to-be-compressed data of a series of numerical values, a difference between numerical values adjacent to each other directly or with a given space therebetween, to generate new compressed data of a series of numerical values each representing the difference, a compression section that subjects the compressed data generated to compression processing, and an estimation section that determines a concentration degree indicating concentration of respective numerical values of the to-be-compressed data generated on a numerical value representing a difference “0”, and estimates a compression degree used when the compressed data is compressed by the compression section, such that the higher the concentration degree is, the higher the compression degree is.

### TECHNICAL FIELD

The present invention relates to a data compression apparatus that subjects to-be-compressed data made up of a series of numerical values to compression processing, a data compression program, and an image-taking apparatus having an image-taking optical system that forms an image by receiving light from a subject and is capable of adjusting an image-formation position.

### BACKGROUND ART

In recent years, techniques for converting image information into electronic data such as image-taking apparatus mainly represented by digital cameras and image-reading apparatus mainly represented by scanners have been developed rapidly. With this development, techniques for subjecting electronic data to compression processing for the purpose of reducing the amount of electronic data also have been developed. Reduction in the amount of electronic data by using such a data compression technique makes it possible to save the storage capacity of a storage medium that stores electronic data and shorten a transmission time to transmit electronic data.

Lately, as a recording apparatus that records electronic data in a storage medium through a buffer memory by compressing the data, there has been proposed a recording device that avoids insufficiency of a buffer memory by increasing a compression ratio used in compressing electronic data when a remaining capacity of the buffer memory is small (see Patent Document 1).

Also, in recent years, image-taking apparatus have been widely used and various types of image-taking apparatus are available on the market. Among the image-taking apparatus, there is an image-taking apparatus that produces data representing a shot image by shooting a moving image and transfers the produced data to a predetermined data-receiving device. This type of image-taking apparatus is often used in such a situation that shot images sent from the image-taking apparatus are observed in real time, such as when wild birds or animals are observed and when watching is carried out through a monitor for security.

When transferring image data obtained by moving-image shooting to a data-receiving device, it is desirable to transfer the image data in a short time. However, the data transfer rate is limited depending on an interface standard (e.g. USB 2.0) used in data communication and also, the amount of image data representing a moving image is generally large. Therefore, in order to complete the transfer of the image data, it is necessary to perform data compression processing. In recent years, there has been proposed an image-taking apparatus having a function of changing a compression ratio according to the amount of image data or a communication speed in data communication (see, for example, Patent Document 2).

Patent Document 1: Japanese Patent Application Laid-Open No. H11-176097

Patent Document 2: Japanese Patent Application Laid-Open No. 2000-261723

### DISCLOSURE OF INVENTION

Like the recording device described in Patent Document 1 and the image-taking apparatus described in Patent Document 2, in the field of apparatus that executes data processing including compression processing for electronic data, it is not rare that information about what level of compression ratio is achieved by the compression processing is required for the purpose of processing the data after being compressed. The compression ratio can be obtained by analyzing the amount of data after the compression processing, but this method is not efficient because a stage for analyzing the amount of data is newly added as a stage subsequent to a stage for the compression processing, making a data-processing time longer.

In view of the foregoing, it is an object in one aspect of the present invention to provide a data compression apparatus, a data compression program and an image-taking apparatus which perform estimation of the compression ratio and is adequate for reducing an operation time.

According to the invention, a data compression apparatus includes:

a differential generation section that determines, for a series of numerical values of to-be-compressed data made up of a series of numerical values, a difference between numerical values adjacent to each other directly or with a given space therebetween, so as to generate new to-be-compressed data made up of a series of numerical values each representing the difference;

a compression section that subjects the new to-be-compressed data generated by the differential generation section to compression processing; and

an estimation section that determines a concentration degree indicating concentration of respective numerical values of the new to-be-compressed data generated by the differential generation section on a numerical value representing a difference “0”, and estimates a compression degree used when the new to-be-compressed data is compressed by the compression section, such that the higher the concentration degree is, the higher the compression degree is.

Here, in the data compression apparatus according to the invention, it is preferable that the compression section has a plurality of compression processing sections that perform compression processing in methods different from each other, the estimation section estimates a compression degree in at least one of the plurality of compression processing sections, and the data compression apparatus further includes a selection section that selects a compression processing section according to the compression degree estimated by the estimation section from among the plurality of compression processing sections, and causes the compression section to output compressed data obtained by the selected compression processing section as output data. And in the data compression apparatus according to the invention, it is also preferable that the compression section has a compression parameter set therein to adjust the compression degree and performs compression processing according to the compression parameter, and the data compression apparatus further includes a compression parameter setting section that sets the compression parameter in the compression section according to the compression degree estimated by the estimation section.

In addition, in the data compression apparatus according to the invention, it is preferable that, for numerical values of to-be-compressed data which represents a two-dimensional image by a series of numerical values, a two-dimensional difference between numerical values adjacent to each other directly or with a given space therebetween is determined.

Further, in the data compression apparatus according to the invention, it is also preferable that the differential generation section generates, as the new to-be-compressed data, to-be-compressed data made up of a series of numerical values in which the difference is represented by a predetermined unit bit number,

the compression section includes:

an offset section that offsets each numerical value of the new to-be-compressed data generated by the differential generation section by a predetermined value;

a division section that divides each of numerical values of the to-be-compressed data having the numerical value offset by the offset section into a higher-order bit portion and a lower-order bit portion, at a predetermined division bit number smaller than the predetermined unit bit number, thereby dividing the to-be-compressed data into higher-order data made up of a series of the higher-order bit portions of the respective numerical values and lower-order data made up of a series of the higher-order bit portions of the respective numerical values; a lower-order-data compression section that subjects the lower-order data obtained as a result of division by the division section to reversible compression processing; and a higher-order-data compression section that subjects the higher-order data obtained as a result of the division by the division section to reversible compression processing, and the estimation section determines a concentration degree indicating concentration of respective numerical values of the to-be-compressed data having the numerical value offset by the offset section on the predetermined value, and estimates the compression degree such that the higher the concentration degree is, the higher the compression degree is.

Here, it is preferable that the higher-order-data compression section includes a first encoding section that directly outputs numerical values except one or a plurality of predetermined to-be-compressed numerical values in the higher-order data, and outputs the to-be-compressed numerical values through encoding the to-be-compressed numerical values into the to-be-compressed numerical values and numerical values representing the consecutive number of the to-be-compressed numerical values identical to the to-be-compressed numerical value. It is further preferable that the higher-order-data compression section includes: a first encoding section that directly outputs numerical values except one or a plurality of predetermined to-be-compressed numerical values in the higher-order data, and outputs the to-be-compressed numerical values by encoding the to-be-compressed numerical values into a to-be-compressed numerical value and into a numerical value representing the number of consecutive to-be-compressed numerical values each identical to the to-be-compressed numerical value; and a second encoding section that subjects the data after being encoded by the first encoding section to entropy coding by using a table that associates codes with numerical values. It is further preferable that the higher-order-data compression section includes:

a first encoding section that directly outputs numerical values except one or a plurality of predetermined to-be-compressed numerical values in the higher-order data, and outputs the to-be-compressed numerical values by encoding the to-be-compressed numerical values into a to-be-compressed numerical value and into a numerical value representing the number of consecutive to-be-compressed numerical values each identical to the to-be-compressed numerical value; and

a second encoding section that subjects the data after being encoded by the first encoding section to Huffman encoding by using a Huffman table. And it is further preferable that the higher-order-data compression section includes:

a first encoding section that directly outputs numerical values except one or a plurality of predetermined to-be-compressed numerical values in the higher-order data, and outputs the to-be-compressed numerical values by encoding the to-be-compressed numerical values into a to-be-compressed numerical value and into a numerical value representing the number of consecutive to-be-compressed numerical values identical to the to-be-compressed numerical value;

a histogram calculation section that determines a histogram of numerical values which appear in the data after being encoded by the first encoding section;

a code assignment section that assigns, based on the histogram determined by the histogram calculation section, codes to numerical values such that a code having a shorter code length is assigned to a numerical value of a higher frequency of occurrence, in a table associating codes with numerical values; and

a second encoding section that subjects the data after being encoded by the first encoding section to entropy coding by using the table in which the codes are assigned by the code assignment section.

In addition, in the data compression apparatus including the offset section and so on according to the invention, it is preferable that the lower-order-data compression section subjects the lower-order data to entropy coding by using a table associating codes with numerical values. It is further preferable that the lower-order-data compression section subjects the lower-order data to Huffman encoding by using a Huffman table. Here, it is acceptable that the lower-order-data compression section outputs the lower-order data without performing compression upon receipt of an instruction of compression omission.

According to the invention, a data compression program incorporated in an information processing apparatus that executes a program and causing the information processing apparatus to execute data compression processing implements, in the information processing apparatus:

a differential generation section that determines, for a series of numerical values of to-be-compressed data made up of a series of numerical values, a difference between numerical values adjacent to each other directly or with a given space therebetween, so as to generate new to-be-compressed data made up of a series of numerical values each representing the difference;

a compression section that subjects the compressed data generated by the differential generation section to compression processing; and

an estimation section that determines a concentration degree indicating concentration of respective numerical values of the new to-be-compressed data generated by the differential generation section on a numerical value representing a difference “0”, and estimates a compression degree used when the to-be-compressed data is compressed by the compression section, such that the higher the concentration degree is, the higher the compression degree is.

Incidentally, with respect to the data compression program according to the present invention, only the basic aspect is described here. However, this is simply for avoiding duplication and the data compression program according to the present invention includes various modes as well as the basic aspect.

In addition, with respect to the elements such as the differential generation section which are implemented in a computer, either one of the elements may be composed of a single program component or either one of the elements may be composed of plural program components or plural elements of the elements maybe composed of a single program component. In addition, the elements may be configured to be self-executable for executing the operations or to give an instruction to cause another program or a program component which are incorporated in a computer to perform the operations.

According to the invention, a first image-taking apparatus includes:

an image-data generation section that generates image data made up of a series of numerical values representing an image of a subject, by taking the image of the subject;

a reversible compression section that subjects the image data generated by the mage-data generation section to reversible compression processing; a irreversible compression section that subjects the image data generated by the mage-data generation section to irreversible compression processing; and

a selection transmission section that selectively transmits, to a predetermined data-receiving device, one of the image data after being subjected to the reversible compression processing by the reversible compression section and the image data after being subjected to the irreversible compression processing by the irreversible compression section, wherein

the reversible compression section includes a first estimation section that estimates a compression degree used by the reversible compression section,

the irreversible compression section includes:

a thinning processing section that takes out numerical values from a series of numerical values of the image data generated by the image-data generation section thereby creating first image data made up of a series of the numerical values taken out and second image data made up of a series of remaining numerical values;

a first compression section that subjects the first image data to reversible compression processing;

a second compression section that subjects the second image data to irreversible compression processing according to a set compression parameter;

a second estimation section that estimates a compression degree used by the irreversible compression section; and

a compression parameter setting section that sets a compression parameter in the second compression section according to an estimated value obtained by the second estimation section, so as to keep the compression degree used by the irreversible compression section higher than a predetermined second compression degree that is higher than a predetermined first compression degree so determined as to fit image data in a limit of an amount of data transmitted by the selection transmission section, and

the selection transmission section transmits compressed data obtained by the reversible compression section when an estimated value obtained by the first estimation section is higher than the first compression degree, and transmits compressed data obtained by the irreversible compression section when the estimated value is low.

Here, in the first image-taking apparatus according to the invention, it is acceptable that the image-taking apparatus further includes:

an environment information obtaining section that obtains, as the image-taking environmental data, image-taking environmental data representing at least one of pieces of information representing a sound, a wind velocity, a temperature, a humidity and an atmospheric pressure in an image-taking environment; and

an environment information adding section that adds the image-taking environmental data obtained by the environment information obtaining section to the image data compressed by the irreversible compression section,

wherein the second compression degree is set to fit a sum of the image data and the image-taking environmental data in the limit of the amount of data transmitted by the selection transmission section.

In addition, in the first image-taking apparatus including the environment information obtaining section according to the invention, it is preferable that the reversible compression section includes:

a first differential generation section that determines a difference between numerical values adjacent to each other, for a series of numerical values of image data generated by the image-data generation section, so as to generate new image data made up of a series of numerical values each representing the difference; and

a compression processing section that subjects the image data generated by the first differential generation section to reversible compression processing,

the first estimation section determines a concentration degree indicating concentration of respective numerical values of the image data generated by the first differential generation section on a numerical value representing a difference “0”, and estimates a compression degree used when the image data is compressed by the compression processing section, such that the higher the concentration degree is, the higher the compression degree is,

the first compression section includes a second differential generation section that determines a difference between numerical values adjacent to each other, for a series of numerical values of first image data, thereby generating new image data made up of a series of numerical values each representing the difference, and the first compression section subjects the image data generated by the second differential generation section to irreversible compression processing, and

the second estimation section determines a concentration degree indicating concentration of respective numerical values of the image data generated by the second differential generation section on a numerical value representing a difference “0”, and estimates a compression degree used when the image data is compressed by the irreversible compression section, such that the higher the concentration degree is, the higher the compression degree is.

Incidentally, as the compression method in which the data of the difference is obtained and the data of the difference is compressed in such way is a typical example that may be employed in the reversible compressing process in the above-described compression processing section of the reversible compression section and in the reversible compressing process in the above-described first compression section of the irreversible compression section, another compression method as well as the compression method may employed in the above-described compression processing section and the above-described first compression section. For example, a reversible compression processing such as run-length encoding or entropy encoding may be applied directly to the image data generated by the image-data generation section without the processing of obtaining the data of the difference. In addition, as the above-described method in which the compression degree is estimated based on the data of the difference, is a typical example of the compression method or the estimation method employed in the above-described first estimation section or the above-described second estimation section, another method as well as the estimation method may be employed in the in the above-described first estimation section and the above-described second estimation section. For example, an estimation method in which the image data generated by the image data generation section is directly used to obtain a concentration degree to a numerical value having the highest frequency of occurrence appearing in an image so as to estimate the compression ration may be employed.

In addition, in the first image-taking apparatus according to the invention in which the first estimation section and the second estimation section obtain the concentration degree to the difference “0”, it is preferable that at least one of the first differential generation section and the second differential generation section determines a two-dimensional difference between a numerical value of image data targeted for a difference and a numerical value adjacent to the numerical value in each of a plurality of directions when viewed on the image.

In addition, in the first image-taking apparatus according to the invention in which the two-dimensional difference is obtained, it is further preferable that the image-data generation section generates, as the image data, image data made up of a series of numerical values represented by a predetermined unit bit number,

the second compression section includes:

a determination section in which a determination criterion is set and which determines an edge portion in the image based on the determination criterion; and

a data conversion section that outputs a predetermined code in a bit number smaller than the predetermined unit bit number, when a numerical value of the second image data created by the thinning processing section is not an edge portion, and re-expresses the numerical value in a bit number smaller than the predetermined unit bit number and larger than the bit number of the predetermined code so as to output the re-expressed numerical value, when the numerical value is an edge portion, and

the compression parameter setting section sets a severer determination criterion for a larger compression degree estimated by the second estimation section, so as to reduce an image portion assumed to be the edge portion. Here, it is preferable that the data conversion section cuts off lower digits of a bit value in the predetermined unit bit number, when re-expressing the numerical value in the bit number smaller than the predetermined unit bit number and larger than the bit number of the predetermined code.

In addition, in the first image-taking apparatus according to the invention in which the first estimation section and the second estimation section obtain the concentration degree to the difference “0”, it is preferable that the first differential generation section generates, as the image data, image data made up of a series of numerical values in which the difference is represented by a predetermined bit number,

the compression processing section includes:

a first offset section that offsets each numerical value of the new image data generated by the first differential generation section by a predetermined value;

a first division section that divides each of numerical values of the image data having the numerical value offset by the first offset section into a higher-order bit portion and a lower-order bit portion, at a predetermined division bit number smaller than the predetermined unit bit number, so as to divide the image data into higher-order data made up of a series of the higher-order bit portions of the respective numerical values and lower-order data made up of a series of the higher-order bit portions of the respective numerical values;

a first lower-order-data compression section that subjects the lower-order data obtained as a result of division by the first division section to reversible compression processing; and

a first higher-order-data compression section that subjects the higher-order data obtained as a result of division by the first division section to reversible compression processing,

the first compression section includes:

a second offset section that offsets each numerical value of the new image data generated by the second differential generation section by a predetermined value;

a second division section that divides each of numerical values of the image data having the numerical value offset by the second offset section into a higher-order bit portion and a lower-order bit portion, at a predetermined division bit number smaller than the predetermined unit bit number, so as to divide the image data into higher-order data made up of a series of the higher-order bit portions of the respective numerical values and lower-order data made up of a series of the higher-order bit portions of the respective numerical values;

a second lower-order-data compression section that subjects the lower-order data obtained as a result of division by the second division section to reversible compression processing; and

a second higher-order-data compression section that subjects the higher-order data obtained as a result of the division by the second division section to reversible compression processing,

the first estimation section determines a concentration degree indicating concentration of respective numerical values of the image data having the numerical value offset by the first offset section on the predetermined value, so as to estimate the compression degree used by the reversible compression processing section, and

the second estimation section determines a concentration degree indicating concentration of respective numerical values of the image data having the numerical value offset by the second offset section on the predetermined value, so as to estimate the compression degree used by the irreversible compression processing section.

Here, it is preferable that at least one of the first higher-order-data compression section and the second higher-order-data compression section directly outputs numerical values except one or a plurality of predetermined to-be-compressed numerical values in the higher-order data, and outputs the to-be-compressed numerical values by encoding the to-be-compressed numerical values into a to-be-compressed numerical value and into a numerical value representing the number of consecutive to-be-compressed numerical values identical to the to-be-compressed numerical value. It is further preferable that the image-taking apparatus further includes:

a first encoding section in which at least one of the first higher-order-data compression section and the second higher-order-data compression section directly outputs numerical values except one or a plurality of predetermined to-be-compressed numerical values in the higher-order data, and outputs the to-be-compressed numerical values by encoding the to-be-compressed numerical values into a to-be-compressed numerical value and into a numerical value representing the number of consecutive to-be-compressed numerical values each identical to the to-be-compressed numerical value; and

a second encoding section that subjects data after being encoded by the first encoding section to entropy coding by using a table that associates codes with numerical values. It is further preferable that the image-taking apparatus further includes:

a first encoding section in which at least one of the first higher-order-data compression section and the second higher-order-data compression section directly outputs numerical values except one or a plurality of predetermined to-be-compressed numerical values in the higher-order data, and outputs the to-be-compressed numerical values by encoding the to-be-compressed numerical values into a to-be-compressed numerical value and into a numerical value representing the number of consecutive to-be-compressed numerical values each identical to the to-be-compressed numerical value; and

a second encoding section that subjects data after being encoded by the first encoding section to Huffman encoding by using a Huffman table. And, it is further preferable that the image-taking apparatus further includes:

a first encoding section in which at least one of the first higher-order-data compression section and the second higher-order-data compression section directly outputs numerical values except one or a plurality of predetermined to-be-compressed numerical values in the higher-order data, and outputs the to-be-compressed numerical values by encoding the to-be-compressed numerical values into a to-be-compressed numerical value and into a numerical value representing the number of consecutive to-be-compressed numerical values each identical to the to-be-compressed numerical value;

a histogram estimation section that determines a histogram of numerical values which appear in data after being encoded by the first encoding section;

a code assignment section that assigns, based on the histogram determined by the histogram estimation section, codes to numerical values such that a code having a shorter code length is assigned to a numerical value of a higher frequency of occurrence, in a table associating codes with numerical values; and

a second encoding section that subjects the data after being encoded by the first encoding section to entropy coding by using the table in which the codes are assigned by the code assignment section.

In addition, in the first image-taking apparatus according to the invention including the first division section and the second division section, it is preferable that at least one of the first lower-order-data compression section and the second lower-order-data compression section subjects entropy coding to the lower-order data by using a table associating codes with numerical values. It is further preferable that at least one of the first lower-order-data compression section and the second lower-order-data compression section subjects Huffman encoding to the lower-order data by using a Huffman table. It is acceptable that at least one of the first lower-order-data compression section and the second lower-order-data compression section outputs the lower-order data without performing compression upon receipt of an instruction of compression omission.

According to the present invention, a second image-taking apparatus includes:

an image-taking optical system that forms an image by receiving light from a subject and is capable of adjusting an image-formation position;

an imaging section that captures the image formed by the image-taking optical system, so as to output image data that expresses the image by a group of pixels and is made up of a series of pixel values of the respective pixels;

a differential generation section that determines a difference between numerical values adjacent to each other, for a series of pixel values of the image data outputted by the imaging section, so as to generate differential data made up of a series of numerical values each representing the difference;

a concentration-degree measuring section that measures a concentration degree indicating concentration of respective numerical values of the differential data generated by the differential generation section on a numerical value representing a difference “0”; and

an image-formation-position adjustment section that checks the concentration degree measured by the concentration-degree measuring section while adjusting the image-formation position of the image-taking optical system, so as to direct the image-formation position of the image-taking optical system toward an image-formation position that indicates the concentration degree being a local minimum.

Here, it is preferable that the second image-taking apparatus according to the present invention further includes: an offset section that offsets each numerical value of the differential data generated by the differential generation section by a predetermined value, wherein

the concentration-degree measuring section measures a concentration degree indicating concentration of the respective numerical values offset by the offset section on a numerical value identical to the predetermined value, so as to indirectly measure the concentration degree indicating the concentration of the numerical values of the differential data generated by the differential generation section on the numerical value representing the difference “0”.

In addition, it is also preferable that the second image-taking apparatus according to the present invention further includes:

an offset section that offsets each of numerical values of the differential data generated by the differential generation section by a predetermined value, wherein

the concentration-degree measuring section includes a voltage-signal generator that outputs a voltage signal of a voltage value according to an absolute value of a difference between each of the numerical values offset by the offset section and the predetermined value, and an integrator that integrates the voltage signal outputted by the voltage-signal generator.

In addition, it is also preferable that the differential generation section generates the differential data as new image data made up of a series of numerical values each representing the difference in a predetermined unit bit number,

the image-taking apparatus further includes an offset section that offsets each of numerical values of the image data generated by the differential generation section by a predetermined value,

the concentration-degree measuring section measures a concentration degree indicating concentration of the respective numerical values offset by the offset section on a numerical value identical to the predetermined value, so as to indirectly measure the concentration degree indicating the concentration of the numerical values of the image data generated by the differential generation section on the numerical value representing the difference “0”, and

the image-taking apparatus further includes:

a division section that divides each of numerical values of the image data having the numerical value offset by the offset section into a higher-order bit portion and a lower-order bit portion, at a predetermined division bit number smaller than the predetermined unit bit number, thereby dividing the image data into higher-order data made up of a series of the higher-order bit portions of the respective numerical values and lower-order data made up of a series of the higher-order bit portions of the respective numerical values;

a lower-order-data compression section that subjects the lower-order data obtained as a result of division by the division section to reversible compression processing; and

a higher-order-data compression section that subjects the higher-order data obtained as a result of the division by the division section to reversible compression processing.

According to the above-described data compression apparatus or the above-described data compression program of the present invention, estimation of the compression ratio is performed based on data of the difference, and it is obtained promptly what extent target data to be compressed may be compressed to. By using the method, for example, in a case where plural methods different from each other are performed for data and compressed data to be an output target is selected from among the pieces of compressed data based on estimated values of compression degree, or in a case where a compression parameter to determine compression degree is changed according to an estimated value of compression degree, a high operation efficiency is obtained.

In addition, when differences for a series of numerical values of image data are determined, if two-dimensional differences are obtained, it is possible to take the intensity of two-dimensional correlation between pixels in an image into consideration, so that the compression degree is further precisely determined.

In addition, a numerical value is offset and subsequently divided in higher-order data and lower-order data, and each of data is subjected to the reversible compression. Thus, it is possible to perform compression processing each appropriate for each of the higher-order data and the lower-order data, so that a high compression degree is obtained. Further, since the difference data is generated in the process of compression processing, it is possible to share the data.

In addition, if the above-described higher-order data compression section includes the first encoding section, only a to-be-compressed numerical value is encoded to a numerical value representing the to-be-compressed numerical value and the number of the consecutive numerical values. Therefore, an event in which the redundancy is increased in avoided so that the compression ratio is improved.

In addition, when at least one of the first higher-order data compression section and the above-described second higher-order data compression section includes the second encoding section, it is expected that the expression ratio is further improved by the entropy encoding (typically, Huffman encoding).

In addition, when at least one of the first higher-order data compression section and the above-described second higher-order data compression section includes the histogram calculation section and the code assignment section, and the second encoding section applies an entropy encoding (for example, Huffman encoding) using a table to which codes are assigned, it is possible to much further improve the compression ratio comparing to an entropy encoding using a table in which code assignment is fixed.

In addition, if the lower-order compression section applied the entropy encoding (typically, Huffman encoding), further improvement of the compression is expected.

In addition, the above-described lower-order data compression section receives an instruction of compression omit to output the lower-order data without compression, it is possible to select a further high-speed compressing process by such instruction.

According to the above-described first image-taking apparatus of the present invention, the selection transmission section transmits, if the compression degree estimated by the first estimation section is higher than the first compression degree, the image data subjected to the reversible compression process by the above-described reversible compression section so that the image quality before compressed is maintained. In addition, if the compression degree estimated by the first compression degree is lower that the first compression degree, the selection transmission section transmits the image data subjected to the irreversible compressing process by the above-described irreversible compression section and maintained to a compression degree higher than the second compression degree to the above-described data receiving apparatus, so that it is possible to provide a margin in the transmission thanks to a small amount of data. Thus, the data selection transmission section selects the data to be transmitted, so that to suppress deterioration of the image quality and to reduce the transmission time as much as possible may be compatible in balance. Here, when the selection transmission section transmits the image data subjected to the irreversible compressing process, such an application is conceivable that, utilizing that the data amount of the image data is sufficiently small, the environment information representing at least one of a sound, a wind velocity, a temperature, a humidity and an atmospheric pressure in a shooting environment is added to the image data to be transmitted. With this, a user may obtain information about the shooting environment as well as the image, and so, it is preferable because a slight deterioration of the image quality due to the irreversible compressing process is compensated.

In addition, when the reversible compressing process is performed, data of a difference between numerical values of image data is obtained and the data of the difference is subjected to the reversible compressing process so that a high compression degree is realized. In addition, estimation of the compression degree is performed for the data of the difference so that the precision of the estimated value of the compression degree is improved.

In addition, in the above-described image-taking apparatus according to the invention, when a difference between numerical values adjacent of each other is obtained for a series of numerical values of image data, if a two-dimensional difference is obtained, it is possible to take an intensity of a two-dimensional correlation between pixels of the image into consideration and so the compression degree may be obtained further precisely.

In addition, the above-described determination section and that data conversion section are provide so that the compression degree of the irreversible compressing process performed by the irreversible compression section may be controlled. At this moment, the data conversion section performs, in order to re-express the numerical value, processing of cutting-off lower-order bits of a bit value in a unit bit number, so that only small features which are comparatively inconspicuous features of the image are cut off and the amount of the date is reduced.

In addition, after the numerical value is offset and subsequently divided into the higher-order data and the lower-order data. For each of the higher-order data and the lower-order data is subjected to the reversible compressing process, so that it is possible to perform the compressing processing appropriate for each feature of the higher-order data and the lower-order data, and a high compression degree may be obtained. In addition, the data of the difference is generated in the process of compressing so that the data may be shared.

In addition, when at least one of the above-described first higher-order compression section and the second higher-order data compression section includes the first encoding section, only a to-be-compressed numerical value is encoded into the to-be-compressed numerical value and a numerical value representing the number of the consecutive numerical values. Therefore, such a situation that the redundancy is increased than the original data is avoided and the compression ratio is improved.

In addition, when at least one of the first higher-order data compression section and the above-described second higher-order data compression section includes the second encoding section, further improvement of the compression ratio may be expected thanks to the entropy encoding (typically, Huffman encoding).

Further, when at least one of the above-described first higher-order data compression section and the above-described second higher-order data compression section includes the histogram calculation section and the code assignment section, and the second encoding section applies an entropy encoding (for example, Huffman encoding) using a table to which codes are assigned, it is possible to much further improve the compression ratio comparing to the entropy encoding using a table in which code assignment is fixed.

In addition, when at least one of the above-described first higher-order data compression section and the above-described second higher-order data compression section applies an entropy encoding (for example, Huffman encoding), further improvement of the compression is expected.

In addition, when at least one of the above-described first higher-order data compression section and the above-described second higher-order data compression section receives an instruction of compression omit to output the lower-order data without compression, it is possible to select a further high-speed compressing process according to such instruction.

The invention of the second image-taking apparatus according to the present invention is based on that it is found it possible to confirm a focusing position based on a difference between pixels of an image. In the second image-taking apparatus according to the present invention, a simple calculation method of obtaining the difference is used so that it is possible to perform sequential processing by a simple circuit configuration. Therefore, it is possible to perform focusing in real time without hindering the data stream. Thus, according to the second image-taking apparatus of the present invention, prompt focusing and cost suppression are compatible.

According to the second image-taking apparatus provided with the above-described offset section, it becomes easy to measure a concentration degree to a numerical value representing the difference “0.”

The above-described concentration measurement section provided with the voltage-signal generator and the integrator may be realized in a small size and a low cost.

The second image-taking apparatus according to a mode in which each numerical values is divided in the higher-order data and the lower-order data to be compressed, the compressing process is performed according to each of the higher-order data and the lower-order data, so that the compression ratio may be improved as a whole. In addition, the data in the compressing process may be shared also for focusing so that unintentional increase of a circuit size and an amount of data processing may be suppressed.

### BRIEF DESCRIPTION OF DRAWINGS

FIG. 1 is a schematic diagram of a camera system using USB.

FIG. 2 is an internal block diagram of a USB camera.

FIG. 3 is a diagram that illustrates a structure of image data to be inputted into the reversible compression processing section in FIG. 2

FIG. 4 is a diagram that illustrates a structure of the data after the data is subjected to the two-dimensional differential encoding processing.

FIG. 5 is a diagram that illustrates the two-dimensional differential encoding processing in the first differential encoding section of the compression processing section 500 in FIG. 2, by way of example.

FIG. 6 is a diagram that illustrates an example of the image data.

FIG. 7 is a diagram that illustrates an effect of the differential encoding and the offset applied to the image data.

FIG. 8 is a diagram that explains an effect of the data division by the first plane division section.

FIG. 9 is a diagram to explain the encoding in the run-length encoding section illustrated in FIG. 2.

FIG. 10 is a diagram that illustrates an algorithm of the encoding that targets the to-be-compressed numerical values in the run-length encoding section.

FIG. 11 is a diagram that illustrates an example of the encoding processing according to the number of consecutive pieces in the run-length encoding section in FIG. 2.

FIG. 12 is a diagram that illustrates an example of the result obtained by scanning of the data scanning section.

FIG. 13 is a diagram illustrating an example of Huffman table.

FIG. 14 is a diagram that illustrates specific examples of the code string prepared in the Huffman table.

FIG. 15 illustrates two histograms showing peaks different in sharpness.

FIG. 16 is a schematic block diagram that illustrates a structure of the first compression ratio estimation section in FIG. 2.

FIG. 17 is a diagram that illustrates a concept of the thinning processing performed by the thinning processing section in FIG. 2.

FIG. 18 is a diagram that illustrates an encoding method of encoding into the 4-bit code.

FIG. 19 illustrates how the estimated value of the compression ratio of the data transmitted to the personal computer 4 by the output switching section 501 in FIG. 2 changes with the passage of time.

FIG. 20 is a functional block diagram of a camera system to which another embodiment of the present invention is applied.

FIG. 21 is an external perspective diagram of the digital camera in FIG. 20 when viewed obliquely from its front face.

FIG. 22 is an external perspective diagram of the digital camera when viewed obliquely from its back face.

FIG. 23 is a schematic block diagram of the digital camera whose external appearance is illustrated in FIG. 21 and FIG. 22.

### BEST MODE FOR CARRYING OUT THE INVENTION

In the following, exemplary embodiments will be explained.

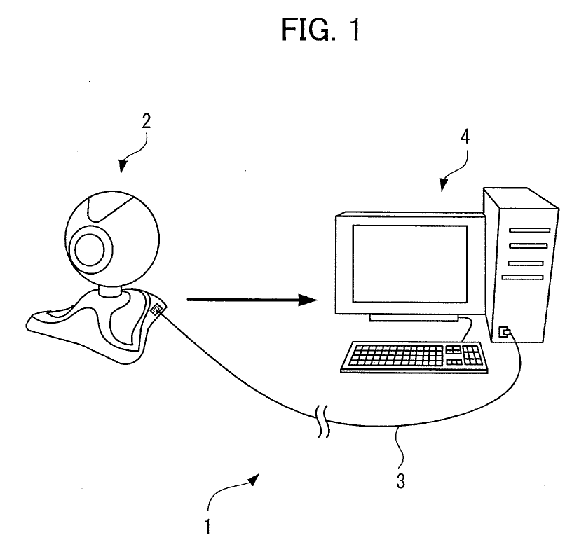

FIG. 1 is a schematic diagram of a camera system using USB.

The camera system illustrated in FIG. 1 includes a USB camera 2, a USB cable and a personal computer 4.

The USB camera 2 includes functions of compressing and transferring image data. This USB camera 2 is an embodiment of the data compression apparatus according to the present invention and is also an embodiment of the image-taking apparatus according to the present invention.

The personal computer 4 includes functions of receiving compressed data transmitted via the USB cable 3 from the USB camera 2 and of decompressing the received compressed data.

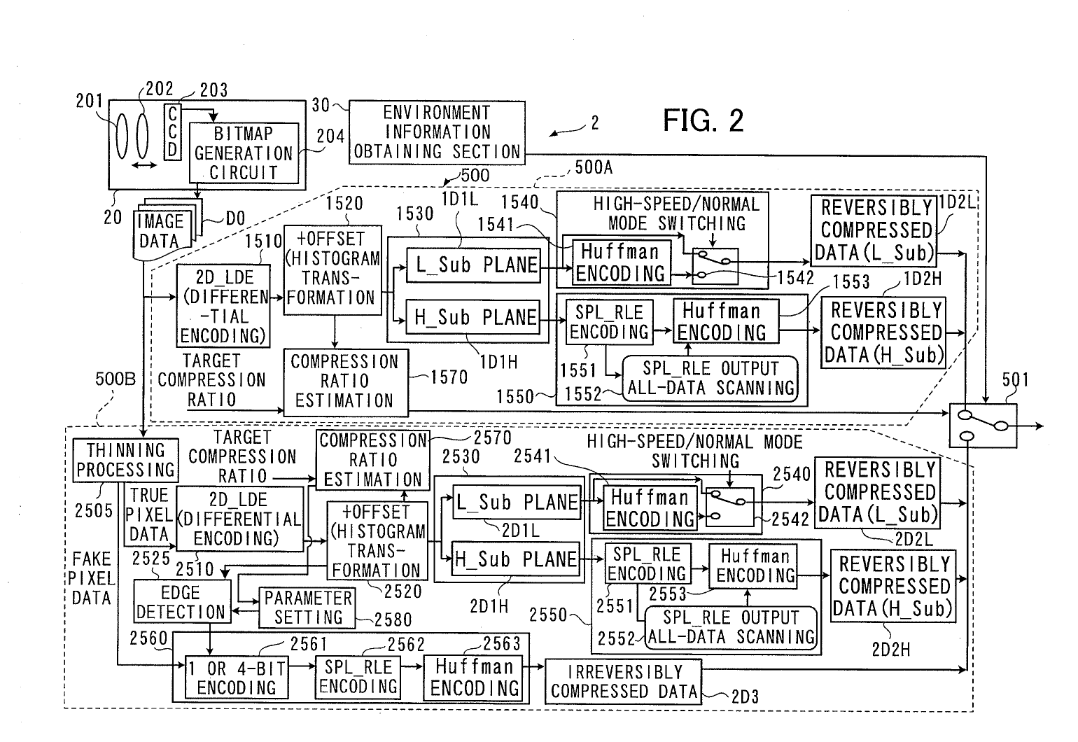

FIG. 2 is an internal block diagram of a USB camera.

The USB camera illustrated in FIG. 2 includes an image-taking section 20 which performs image-taking, an environment information obtaining section 30 which obtains data about an image-taking environmental such as a sound, a wind velocity, a temperature, a humidity and an air pressure and a compression process section 500 which performs a compression process.

The image-taking section 20 includes an object lens 201, a focusing lens 202, a CCD 203 on which object light through these lenses is focused and a bitmap generation section 204.

The bitmap generation section 204 performs image processing such as sampling hold and gain adjustment for a Bayer pattern image according to a CCD array or an analogue signal of each color (R-color, G-color, B-color), which are inputted from the CCD 203, and subsequently, converts each of the signals to a digital signal by an A/D converter which is not illustrated. The bitmap generation section 204 further converts each of the converted signals to a raster image to generate bitmap data for each of the colors.

The environment information obtaining section 30 includes a microphone which converts a sound at the time of image-taking, a temperature sensor which measures a temperature at the time of image-taking to generate an electrical signal representing the temperature and a wind velocity sensor which measures wind power to generate an electrical signal representing the wind power. These electrical signals are processed by the environment information obtaining section 30 to be converted to digital data, and are subsequently sent to an output switching section 501 in the compression processing section 500. In the following, data which is processed by the environment information obtaining section 30 to be converted to digital data is referred to as environment information data.

The compression processing section 500 includes a reversible compression processing section 500A which provides reversible compression processing and an irreversible compression processing section 500B which provides irreversible compression processing. Image data D0 which is developed to be bitmap in the bitmap generation section 204 to be inputted to the compression processing section 500 is inputted to both the reversible compression processing section 500A and the irreversible compression processing section 500B to be subjected to compression processing separately in each of the compression processing sections. In addition, the compression processing section 500 includes an output switching section 501 to which image data reversibly compressed by the reversible compression processing section 500A and data reversibly compressed by the reversible compression processing section 500B are inputted. As described later, the output switching section 501 plays a role to switch as to which is outputted between the reversibly compressed image data and the irreversibly compressed image data, according to the estimated value of the compression ratio of the reversible compression processing by the reversible compression processing section 500A.

Here, the reversible compression processing section 500A includes, as sections which perform the reverse compression processing, a first differential encoding section 1510, a first offset section 1520, a first plane division section 1530, a first L-plane compression section 1540, a first H-plane compression section 1550 and a first compression ratio estimation section 1570.

On the other hand, the irreversible compression processing section 500B includes a thinning process section 2505 which thins out a TRUE pixel to be a target for the reversible compression processing from among all pixels making a shot image, and as sections to perform the irreversible compression processing for a pixel which is a remaining pixel after the TRUE pixel is thinned out and is to be a target for the irreversible compression processing, a FAKE-pixel-data compression section 2560, a parameter setting section 2580 and an edge detection section 2525. Further, the irreversible compression processing section 500B includes a second differential encoding section 2510, a second offset section 2520, a second plane division section 2530, a second L-plane compression section 2540, a second H-plane compression section 2550 and a second compression ratio estimating section 2570.

Details of each section in the compression processing section 500 will be explained. Here, in the following, a flow of the compression processing in the compression processing section 500 will be explained.

Firstly, the compression processing in the reversible compression processing section 500A will be explained.

Image data D0 which is inputted in the compression processing section 500 is made of a series of 8-bit numeric values. When the image data D0 is inputted to the reversible compression processing section 500A, the image data D0 is inputted to the first differential encoding section 1510 in the reversible compression processing section 500A. Then, a two-dimensional differential encoding processing, that is, a process is performed in which, for the series of numeric values composing the inputted data, a two-dimensional difference is obtained based on plural numeric values which is adjacent to a numeric value in interest in plural directions respectively when viewed on the image is obtained, to generate image data made of a series of 8-bit numeric values representing the differences. The image data made of the series of numeric values representing the differences and generated in the first differential encoding section 1510 is subsequently subjected to a predetermined offset.

The first compression ratio estimation section 1570 analyzes the image data after the offset to estimate which level of the compression ratio is obtained in the compression processing by the second L-plane compression section 2540 and the second H-plane compression section 2550. Here, the compression ratio represents a ratio of a data amount of the image data after compressed to a data amount of the original image data. In the estimation by the first compression ratio estimation section 1570, as explained later, the larger the deviation of a histogram of the numeric values composing the image data after the offset is, the smaller the estimated value of the compression ratio is. Here, a value to be obtained by subtracting the compression ratio from a value “1” (i.e., a ratio of a decreased amount of the data to an amount of the original image data) corresponds to an example of the compress degree according to the invention. Prior to performing compression processing, a target compression ratio which is a target at the time of the reversible compressing processing in the reversible compression processing section 500A is inputted in advance to the first compression ratio estimation section 1570. The first compression ratio estimation section 1570 determines whether or not the estimated value of the compression ratio is equal to or less that this target compression ratio and outputs a result of the determination to the output switching section 501. Here, this target compression ratio is a compression ratio which provides an upper threshold value for the image data after compressed to be transmitted to the personal computer 4 in a short time with such an extent that when a user views the image on the screen of the personal computer 4 of FIG. 1, the user does not feel that that displaying of the image is slow. And, the target compression ratio corresponds to a compression ratio corresponding to a limit of an amount of output data in the output switching section 501. In the following, the target compression ratio inputted to the first compression ratio estimation section 1570 is referred to as a first target compression ratio.

In the first plane division section 1530, each 8-bit numerical value in the image data after offset is divided into lower-order bit and higher-order bit, so that the image data is divided in a lower-order sub-plane 101L made of a series of numerical values of the lower-order bit and a higher-order sub-plane 1D1H made of a series of numerical values of the higher-order bit. Here, the lower-order sub-plane 1D1L and the higher-order sub-plane 1D1H correspond to an example of the lower-order data and the higher-order data, respectively.

The lower-order sub-plane 1D1L and the higher-order sub-plane 1D1H which are divided in the first plane division section 1530 are subjected to the reversible compression processing in the first L-plane compression section 1540 and the first H-plane compression section 1550, respectively.

The first L-plane compression section 1540 includes a Huffman encoding section 1541. In the Huffman encoding section 1541, encoding processing to replace, according to a Huffman table associating numerical values with codes, the numerical values of the lower-order sub-plane D1L inputted into the Huffman encoding section 1541 with codes following the Huffman table is performed. This Huffman encoding is a kind of entropy encoding. Incidentally, a mode switching section 1542 is incorporated in the first L-plane compression section 1540. The mode switching section 1542 is given an instruction from an user to switch between a fast mode and a normal mode, thereby switching between the normal mode through Huffman encoding by the above-described Huffman encoding section 1541 and the fast mode in which the lower-order sub-plane 1D1L is directly outputted with omitting the Huffman encoding. Accordingly, ultimately from the first L-plane compression section 1540, in a case of the normal mode, the lower-order compressed data 1D2L in which the lower-order sub-plane 1D1L is compressed by the Huffman encoding, and in a case of the fast mode, a lower-order compressed data 1D2L without being subjected to the Huffman encoding is outputted.

On the other hand, the first H-plane compression section 550 includes a run-length encoding section 1551, a data scanning section 1552 and a Huffman encoding section 1553. The higher-order sub-plane 1D1H is inputted into the run-length encoding section 1551 in the first H-plane encoding compression section 1550.

The run-length encoding section 1551 in the first plane encoding compression section 1550 subjects the inputted higher-order sub-plane 1D1H to run-length encoding similar to that performed in the above-described run-length encoding section 1545 in the first L-plane compression section 1540. In the present embodiment, the run-length encoding section 1551 in the first plane encoding compression section 1550 corresponds to the first encoding section according to the invention. The data after encoded by the run-length encoding section 1551 in the first H-plane encoding compression section 1550 is subsequently inputted to both the data scanning section 1552 and the Huffman encoding section 1553. In the data scanning section 1552, all the data after encoded by the run-length encoding section 1551 is scanned and frequencies of occurrence (histogram) for all numerical values which occurs in the data are determined. Here, processing of obtaining the frequencies of occurrence is, in the present embodiment, performed with each higher-order sub-plane D1H illustrated in FIG. 2 as a unit. Frequencies of occurrence of numerical values in the data after encoded by the run-length encoding section 1551, of each higher-order sub-plane 1D1H. In addition, the data scanning section 1552 allocates, based on the obtained data histogram (frequency of occurrence of numerical value), a code with a shorter code length for numerical value with a greater frequency of occurrence. This data scanning section 1552 corresponds to an example of the histogram calculating section and the code allocating section according to the invention.

The Huffman table in which codes are assigned to numerical values is passed to the Huffman encoding section 1553. The Huffman encoding section 1553 performs encoding processing to replace numerical values of the data inputted into the Huffman encoding section 1553 with codes following the Huffman table, i.e., a code in which a numerical value with a greater frequency of occurrence is expressed in a shorter bit length. This Huffman encoding section 1553 corresponds to an example of the second encoding section according to the present invention.

The data after Huffman encoded in the Huffman encoding section 1553 is added with compression information including an allocation table of the numerical values and the codes which are allocated in the data scanning section 1552 and is outputted from the first H-plane compression section 1550 as higher-order compression data 1D2H in which that higher-order sub-plane 1D1H is compressed.

Thus, compressed data obtained by subjecting the original image data to the reversible compression processing is made of a group of the lower-order compressed data 1D2L and the higher-order compressed data 1D2H outputted respectively from the first L-plane compression section 1540 and the first H-plane compression section 1550. This compressed data is inputted to the output switching section 501.

Next, compression processing in the irreversible compression processing section 500B will be explained.

When the image data D0 is inputted into the reversible compression processing section 500A, the image data D0 is divided into pixel data of the TRUE pixel to be a target for the reversible compression processing and pixel data of the FAKE pixel to be target for the irreversible compression processing. A method of dividing these two kinds of pixel data will be explained later.

The pixel data of the TRUE pixel is subjected, by the second differential encoding section 2510, the second offset section 2520, the second plane division section 2530, the second L-plane compression section 2540 and the second H-plane compression section 2550 in the irreversible compression processing section 500B, to reversible compression processing similar to the above-described reversible compression processing by the reversible compression processing section 500A. In other words, for example, a two dimensional difference encoding processing similar to that of the above-described first difference encoding section 1510 is performed in the second differential encoding section 2510, and a predetermined offset is applied to the data after inputted to the second offset section 2520. Then, in the second plane division section 2530, the image data is divided into a lower-order sub-plane 2D1L made of a series of numerical values of lower-order bits and a higher-order sub-plane 2D1H made of a series of numerical values of higher-order bits. The lower-order sub-plane 2D1L and 2D1H higher-order sub-plane are inputted to the second L-plane compression section 2540 and the second H-plane compression section 2550, respectively. The second L-plane compression section 2540 and the second H-plane compression section 2550 include configurations similar to those of the first L-plane compression section 1540 and the first H-plane compression section 1550, respectively. For example, the second L-plane compress section 2540 also includes a Huffman encoding section 2541 and a mode switch section 2542. By using these, processing similar to that in the first L-plane compression section 1540 is applied, and lower-order compression data 2D2L is outputted. On the other hand, the second H-plane compression section 2550 includes a run-length encoding section 2551, a data scanning section 2552, a Huffman encoding section 2553. By using these, processing similar to that in the first H-plane compression section 1550 is applied and then higher-order compressed data 2D2H is outputted.

In contrast, the pixel data of the FAKE image is subjected to the irreversible compression processing by the FAKE-pixel-data compression section 2560. This FAKE-pixel-data compression section 2560 includes a bit reducing section 2561, a run-length encoding section 2562 and a Huffman encoding section 2563. Numerical values included in FAKE pixel data are replaced with codes of 1-bit or 4-bits in the bit reducing section 2561. Here, which one of the two kinds of codes in 1-bit or 4-bits the numerical values included in the FAKE pixel data is replaced with is determined based on whether or not a FAKE pixel value having a pixel value of a numerical value in interest is a pixel value belonging to an edge portion of the image. The determination as to whether or not the FAKE pixel belongs to the edge portion is performed by the edge detection section 2525. In the bit reducing section 2561, based on the determination by the edge detection section 2525, a pixel belonging to the edge portion of the image is replaced with a 4-bits code, and a pixel value of a pixel not belonging to the edge portion is replaced with a 1-bit code. The data replaced with the 1-bit code or the 4-bits code is subjected to processing almost similar to that in the above-described first H-plane compression section 1550 by the run-length encoding section 2562 and the Huffman encoding section 2563. Here, the FAKE-pixel-data compression section 2560 also includes a data scanning section similarly operating as the data scanning section 1550 of the first H-plane compression section 1550, even though its illustration is omitted. The FAKE pixel data after being subjected to the run-length encoding processing is outputted as irreversible compression data 2D3 from the FAKE-pixel-data compression section 2560.

The compressed data obtained by subjecting the original image data D0 to the irreversible compression processing in the irreversible compression processing section 500B is formed by a group including the lower-order compressed data 2D2L outputted by the second L-plane compression section 2540, the higher-order compressed data 2D2H outputted by the second H-plane compression section 2550, and the irreversibly compressed data 2D3. This compressed data is input into the output switching section 501.

The irreversible compression processing section 500B also includes a second compression-ratio estimation section 2570 that analyzes the post-offset image data, thereby estimating what compression ratio is achieved by the reversible compression processing performed by the second L-plane compression section 2540 and the second H-plane compression section 2550. An estimation method used here is similar to that of the first compression ratio estimation section 1570. In the present embodiment, a value, which is obtained by multiplying the estimated value of the compression ratio in this reversible compression processing by a rate (thinning ratio) of the TRUE pixels to all the pixels, is used as a reversible compression processing component of the estimated value of the compression ratio in the entire irreversible compression processing section 500B. Further, in the present embodiment, a value, which is obtained by multiplying the compression ratio in the FAKE-pixel-data compression section 2560 at the time when all the FAKE pixels are virtually subjected to the 4-bit encoding in the FAKE-pixel-data compression section 2560 while not being subjected to the run-length encoding processing and the Huffman encoding processing, by a ratio of the FAKE pixels to all the pixels, is used as an irreversible compression processing component of the estimated value of the compression ratio in the entire irreversible compression processing section 500B. The estimated value of the compression ratio in the entire irreversible compression processing section 500B is obtained as a value representing a sum of the reversible compression processing component of the estimated value of the compression ratio and the irreversible compression processing component of the estimated value of the compression ratio. Here, in this method, the irreversible compression processing component of the compression ratio is constant irrespective of the image data, and the estimated value of the compression ratio in the entire irreversible compression processing section 500B is determined as long as the estimated value of the compression ratio of the reversible compression processing performed by the second L-plane compression section 2540 and the second H-plane compression section 2550 is obtained. Actually, considering the effect of the 1-bit encoding, the run-length encoding processing and the Huffman encoding processing in the FAKE-pixel-data compression section 2560, it is expected that the actual value of the compression ratio in the entire irreversible compression processing section 500B will be smaller than this estimated value. Into the second compression ratio estimation section 2570, before the execution of the compression processing, the target compression ratio that serves as a target of the compression ratio at the time when the compression processing is performed in the irreversible compression processing section 500B is inputted beforehand, and the second compression ratio estimation section 2570 determines whether the estimated value of the compression ratio in the entire irreversible compression processing section 500B is equal to or below this target compression ratio. This target compression ratio is a compression ratio that provides an upper-limit threshold to suppress the entire data amount to a level equal to or below the limit of the amount of output data in the output switching section 501, so that the entire data amount will not be enormous even if the image data after being subjected to the irreversible compression processing and the environment information data are combined. This target compression ratio is smaller than the value of the first target compression ratio. In the following, the target compression ratio inputted into the second compression ratio estimation section 2570 is referred to as a second target compression ratio. The result of the determination by the second compression ratio estimation section 2570 is inputted into the parameter setting section 2580. When there is obtained a determination result indicating that the estimated value of the compression ratio is beyond the value of the second target compression ratio, the parameter setting section 2580 reduces the number of FAKE pixels determined to be at an edge portion, by changing the threshold parameter set in the edge detection section 2525 to provide a criterion of determination as to whether the pixel is at the edge portion, thereby making the condition for being at the edge portion severe. As a result, the method of the compression processing in the irreversible compression processing section 500B shifts to compression processing in which the compression ratio is smaller and the compression is high. On the other hand, when there is obtained a determination result indicating that the estimated value of the compression ratio is equal to or less than the second target compression ratio, the parameter setting section 2580 loosens the condition for being at the edge portion according to the size of a difference between the estimated value of the compression ratio and the second target compression ratio. As a result, the method of the compression processing in the irreversible compression processing section 500B shifts to compression processing in which the value of the compression ratio is maintained to be equal to or lower than the second target compression ratio so that the compression is not excessive and thus deterioration in the image quality is avoided.

When the estimated value of the compression ratio of the reversible compression processing by the reversible compression processing section 500A is equal to or lower than the above-described first target compression ratio, the output switching section 501 transmits the image data after being subjected to the reversible compression processing by the reversible compression processing section 500A to the personal computer 4 in FIG. 1 through the USB cable 3. On the other hand, when the estimated value of the compression ratio of the reversible compression processing by the reversible compression processing section 500A is beyond the first target compression ratio, the output switching section 501 adds the above-described environment information data to the image data after being subjected to the irreversible compression processing by the irreversible compression processing section 500A, and then transmits the image data to the personal computer 4 in FIG. 1.

The compressed data transmitted to the personal computer 4 is subjected to data decompression processing in the personal computer 4. Here, when the data decompression processing is performed, decoding processing corresponding to the above-described various kinds of encoding processing is applied. Based on the image data after being subjected to the decoding processing, an image is displayed on the display screen of the personal computer 4.

By repetition of the above-described compression processing and decoding processing of the image data, an image is displayed in real time on the display screen of the personal computer 4. At this time, during the time in which the estimated value of the compression ratio of the reversible compression processing performed by the reversible compression processing section 500A is equal to or below the first target compression ratio and thereby high compression is realized, the display of the image with no deterioration in the image quality is maintained on the display screen of the personal computer 4, based on the image data after being subjected to the reversible compression processing by the reversible compression processing section 500A. When the estimated value of the compression ratio in the reversible compression processing performed by the reversible compression processing section 500A goes beyond the first target compression ratio thereby entering a low-compression state, the image data to be transmitted is changed to image data which has been subjected to the irreversible compression processing by the irreversible compression processing section 500B and whose data amount is smaller than that of the image data after being subjected to the reversible compression processing by the reversible compression processing section 500A, in order to avoid an increase in the transmission time. At this moment, an image whose image quality is slightly deteriorated is displayed on the display screen of the personal computer 4. In this case however, based on the environment information data in the transmitted data, environment information at the time of shooting such as a sound around a photographed place, a temperature, a wind velocity, a humidity and an atmospheric pressure at the time of shooting is displayed on the display screen together with the image. As a result, the user can obtain the information on the shooting environment as other information and thus the sacrifice of the image quality is compensated for.

Next, the processing in the compression processing section 500 will be described in detail.

First, the reversible compression processing in the reversible compression processing section 500A of the compression processing section 500 in FIG. 2 will be described in detail.

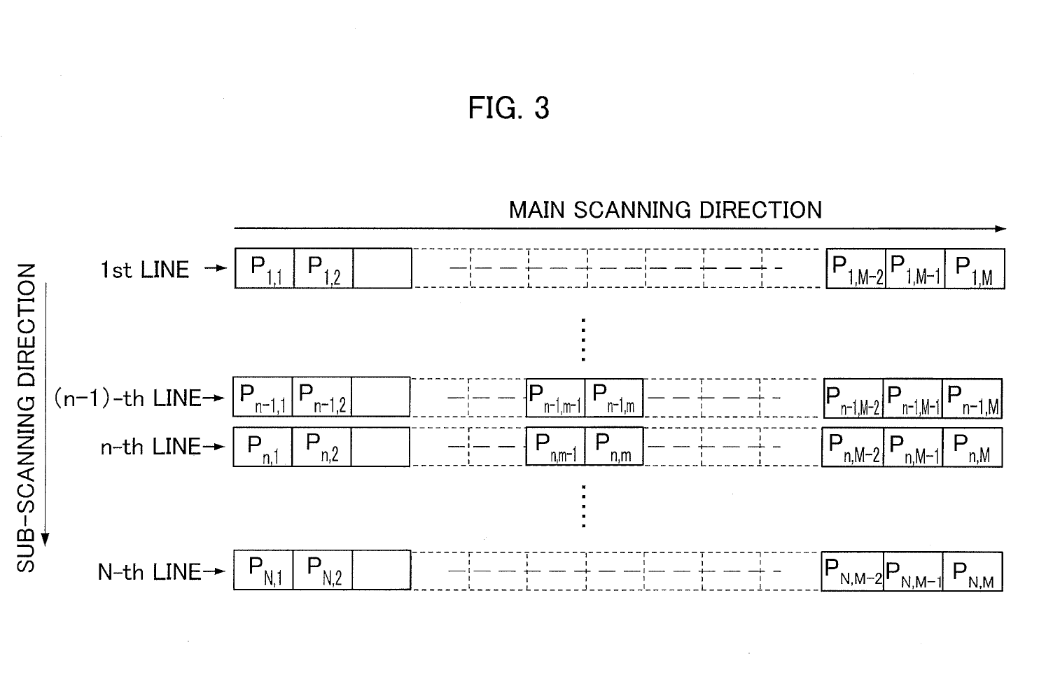

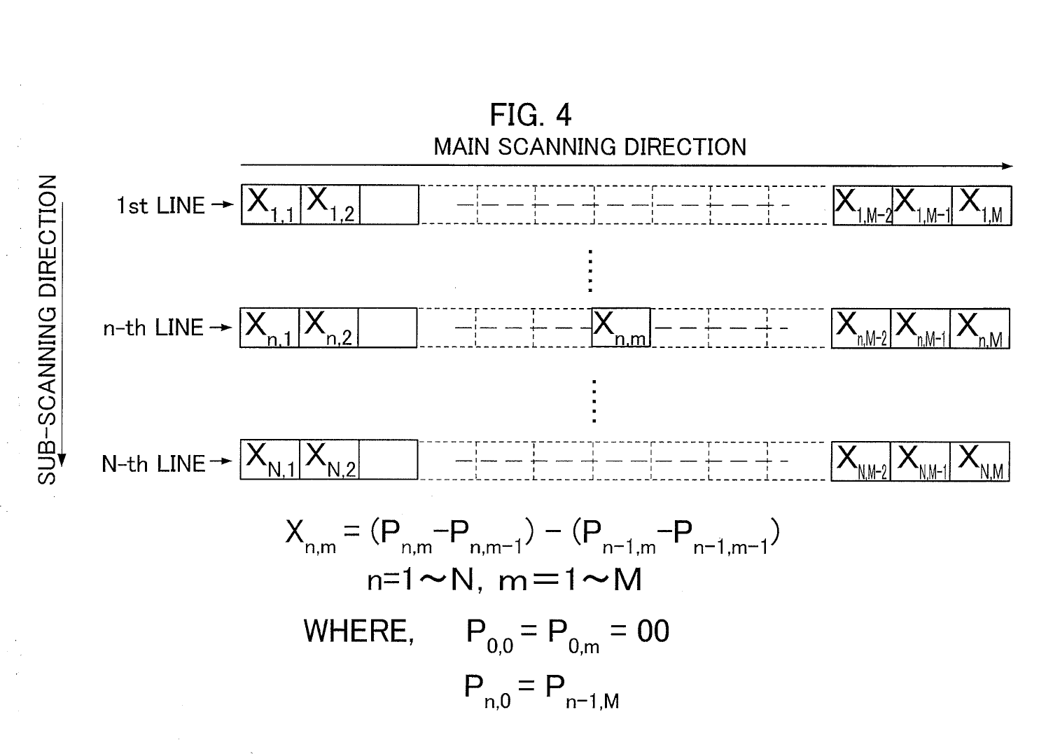

FIG. 3 is a diagram that illustrates a structure of image data to be inputted into the reversible compression processing section 500A in FIG. 2, and FIG. 4 is a diagram that illustrates a structure of the data after the data is subjected to the two-dimensional differential encoding processing.

An image represented by image data has such a structure that N lines, each of which is made up of M pixels aligned in a predetermined main scanning direction, are aligned in a sub scanning direction orthogonal to the main scanning direction. The image data reflects such a structure and thus also is configured such that N lines, each of which is made up of M pixel values aligned in the main scanning direction (a lateral direction in the figure), are aligned in the sub scanning direction (a vertical direction in the figure) as illustrated in FIG. 3. In this figure, the m-th pixel value from left in the n-th line from top is indicated by Pn,m. By using this notation, in the line at the n-th position in the sub-scanning direction, pixel values of the respective pixels aligned in the main scanning direction are indicated by P_{n,1}, P_{n,2}, . . . , P_{n,m-1}, P_{n,m}, . . . , P_{n,M-2}, P_{n,M-1}, P_{n,M} in the alignment order. These pixel values are numerical values expressed in hexadecimal notation.

Here, the image data as described above is inputted into the first differential encoding section 1510 of the compression processing section 500 illustrated in FIG. 2, where the image data is subjected to the two-dimensional differential encoding processing, and a further difference as to the sub-scanning direction in the difference between pixels adjacent to each other in the main scanning direction is determined.

FIG. 4 illustrates the structure of the data after being subjected to the two-dimensional differential encoding processing. This data also has such a structure that N lines, each of which is made up of M pixel values after the two-dimensional differential encoding, are aligned in the main scanning direction. In this figure, the m-th pixel value, after being subjected to the two-dimensional differential encoding, from left in the n-th line from top is indicated by Xn,m. This pixel value Xn,m after the two-dimensional differential encoding is obtained from four pixel values (P_{n-1,m-1}, P_{n-1,m}, P_{n,m-1}, P_{n,m}) before the two-dimensional differential encoding illustrated in a central part of FIG. 3, based on a conversion formula shown below.

X_{n,m}=(P_{n,m}−P_{n-1,m})−(P_{n-1,m}−P_{n-1,m-1}) (1)

Here, in a case of n=1 or m=1, 0 appears as the subscript of the pixel value before the two-dimensional differential encoding on the right side. The pixel value whose subscript is 0 is defined as follows.

P_{0,0}=P_{0,m}=00 (m=1 to M), P_{n0,}=P_{n-1,M}, (n=1 to N) (2)

Here, “00” of the formula (2) indicates that the value is zero when the pixel value is expressed in hexadecimal notation. In the following, the meanings of the formula (1) and the formula (2) will be briefly described.

The formula (1) indicates that the pixel value X_{n,m} after the two-dimensional differential encoding is obtained by the further difference, in the sub-scanning direction, of the difference (i.e., a value in the parenthesis) between pixels adjacent to each other in the main scanning direction. When the correlation between the pixel value P_{n,m} before the two-dimensional differential encoding and its adjacent pixel value is strong (i.e., when these pixel values are similar to each other in terms of size), the pixel value X_{n,m} after the two-dimensional differential encoding is close to zero.

The formula (2) represents the definition of each pixel value when a virtual 0th line in the sub-scanning direction and a virtual pixel value at the 0th position from left in each line are newly provided. In this definition, as to the main scanning direction, the pixel value at the left edge (the 0th pixel value P_{n,0} from left) and the pixel value P_{n-1,M} at the right edge in a line before the line where the pixel value at the left edge is present are regarded as identical. Further, in this definition, as to the sub-scanning direction, the uppermost pixel values in the figure (the pixel values in the 0th line), namely P_{0,0} and P_{0,m} are fixed to 0.

In the data after the two-dimensional differential encoding, as to the pixel value in the first line and the first pixel value in each line, a term where a subscript is “0” appears in the right side of the conversion formula (1). Therefore, the definition of the formula (2) is applied. To be more specific, the pixel value in the first line after the two-dimensional differential encoding is expressed as shown below based on the formula (1) and the formula (2)

X_{1,1}=P_{1,1},

X_{1,2}=P_{1,1}−P_{1,1},

X_{1,3}=P_{1,3}−P_{1,2},

. . .

X_{1,M}=P_{1,M}−P_{1,M-1}.

On the other hand, in the data after the two-dimensional differential encoding, the first pixel value of each line is expressed as shown below based on the formula (2).

X_{1,1}=P_{1,1},

X_{2,1}=(P_{2,1}−P_{1,M})−P_{1,1},

X_{3,1}=(P_{3,1}−P_{2,M})−(P_{2,1}−P_{1,M}),

. . .

X_{N,1}=(P_{N,1}−P_{N-1,M})−(P_{N-1,1}−P_{N-2,M}).

In this way, as to the pixel value in the first line and the first pixel value in each line, the way of the conversion is slightly peculiar. However, to the pixel values other than these pixel values, the formula (1) is directly applied without the definition of the formula (2) being applied. For example, the pixel values except the pixel value at the left edge among the pixel values in the second line are each expressed as shown below.

X_{2,2}=(P_{2,2}−P_{2,1})−(P_{1,2}−P_{1,1}),

X_{2,3}=(P_{2,3}−P_{2,2})−(P_{1,3}−P_{1,2}),

. . .

X_{2,M}=(P_{2,M}−P_{2,M-1})−(P_{1,M}−P_{1,M-1}).

This two-dimensional differential encoding processing will be described using concrete numerical values.

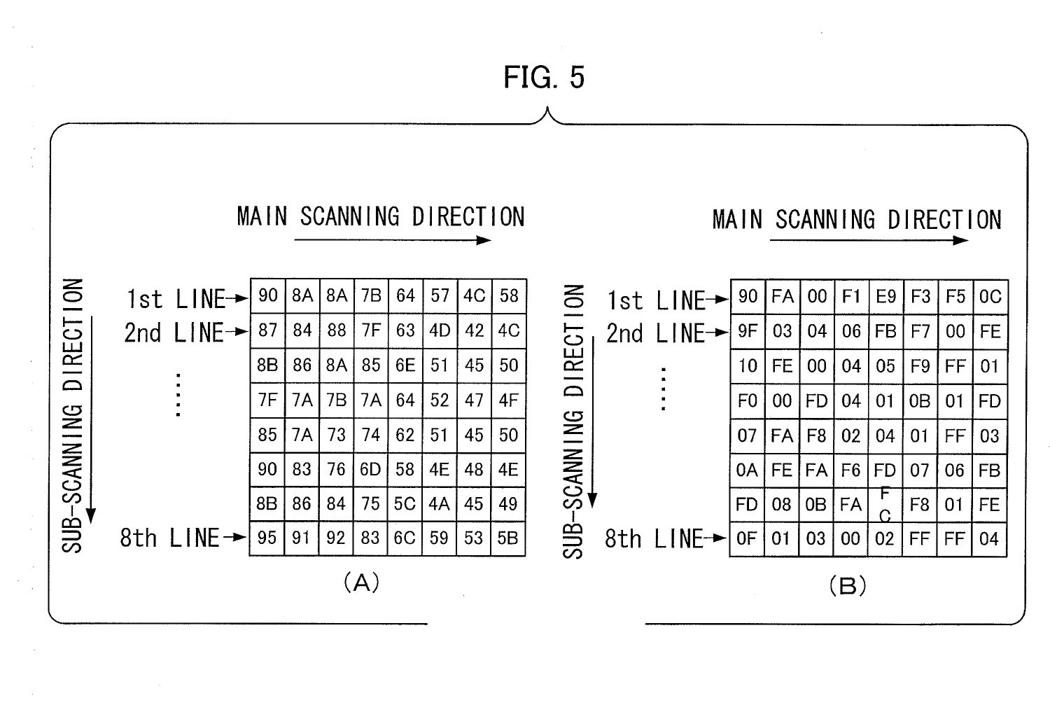

FIG. 5 is a diagram that illustrates the two-dimensional differential encoding processing in the first differential encoding section 1510 of the compression processing section 500 in FIG. 2, by way of example.

Each numerical value illustrated in part (A) of this figure is a pixel value of image data, while each numerical value illustrated in part (B) of this figure is an output value that is outputted by the two-dimensional differential encoding processing. The lateral direction in this figure is the main scanning direction, and a row formed by eight numerical values aligned along the main scanning direction is the above-described line. The data illustrated in this figure includes eight lines in total, each having such eight numerical values aligned therein. This data is equivalent to data in a case where N=8, M=8 in the data illustrated in FIG. 3 and FIG. 4.

In the two-dimensional differential encoding processing applied to the data illustrated in part (A) of FIG. 5, at first, the leftmost “90” among pixel values “90 8A 8A 7B . . . ” in the first line is directly outputted as the above-mentioned X_{1,1} and as the remaining X_{1,2}, X_{1,3} and so on, differential values “8A-90=FA”, “8A-8A=00” and so on between pixel values adjacent to each other in the main scanning direction are outputted. Here, actually, the result of subtracting “90” from “8A” becomes a negative number and is represented by “1FA” in 9 bits. However, the most significant “1” that is 1 bit of MSB is omitted, and only “FA” corresponding to lower-order 8 bits is outputted.

As to the second line, in the following formula to determine X2,1,

X_{2,1}=(P_{2,1}−P_{1,M})−P_{1,1}

where M=8, the numerical values illustrated in part (A) of FIG. 5 are substituted into (P_{2,1}, P_{1,8}, P_{1,1}) in the right side, and “(87−58)−90=9F” is out as X2,1. As the remaining X2,2, X2,3 and so on, there are outputted further differential values “(84−87)−(8A−90)=3”, “(88−84)−(8A−8A)=04” and so on between: differential values between the pixel values adjacent to each other in the main scanning direction in the second line; and differential values between the pixel values adjacent to each other in the main scanning direction in the first line.

As to the third line, in the following formula to determine X3,1,

X_{3,1}=(P_{3,1}−P_{2,M})−(P_{2,1}−P_{1,M})

where M=8, the numerical values illustrated in part (A) of FIG. 5 are substituted into (P_{3,1}, P_{2,8}, P_{2,1}, P_{1,8}) in the right side, and “(8B−4C)−(87−58)=10” is out as X3,1. As the remaining X3,2, X3,3 and so on, there are outputted further differential values “(86−8B)−(84−87)=FE”, “(8A−86)−(88−84)=00” and so on between: differential values between the pixel values adjacent to each other in the main scanning direction in the third line; and differential values between the pixel values adjacent to each other in the main scanning direction in the second line.

As to the fourth line and thereafter as well, each numerical value illustrated in part (B) of FIG. 5 is obtained by repeating the operation same as that of the third line.

In the personal computer 4 illustrated in FIG. 1, the data that has underwent the two-dimensional differential decoding in this way is subjected to the decoding processing. In this decoding processing, a formula to determine Pn,m based on the data after being subjected to the two-dimensional differential decoding is used, and this formula is obtained as follows.

A result of performing addition in the pixel value Xi,j after the two-dimensional differential encoding, from i=1 to i=m and further from j=1 to j=m, is expressed as the following formula (3), by using the formula (1) and the formula (2).

$$\begin{matrix}{\sum }_{i = 1}^{n} {\sum }_{j = 1}^{m} Xi , j = {\sum }_{i = 1}^{n} [ {\sum }_{j = 1}^{m} ( {p}_{i , j} - {p}_{i , j - 1} ) - {\sum }_{j = 1}^{m} ( {p}_{i - 1 , j} - {p}_{i - 1 , j - 1} ) ] \\ = {\sum }_{i = 1}^{n} [ {p}_{i , m} - {p}_{i , 0} ) - ( {p}_{i - 1 , m} - {p}_{i - 1 , 0} ) ] \\ = {\sum }_{i = 1}^{n} [ {p}_{i , m} - {p}_{i - 1 , m} ) - ( {p}_{i , 0} - {p}_{i - 1 , 0} ) ] \\ = ( {P}_{n , m} - {P}_{0 , m} ) - ( {P}_{n , 0} - {P}_{0 , 0} ) \\ = {P}_{n , m} - {P}_{n - 1 , M}\end{matrix} \qquad ( 3 )$$

Here, to {P0,0, Pn,0, P0, m} appearing in the middle of the formula, the formula (2) is applied. Based on this formula, the pixel value Pn,m before the two-dimensional differential encoding is expressed as the following formula (4).

$${P}_{n , m} = {\sum }_{i = 1}^{n} {\sum }_{j = 1}^{m} {X}_{i , j} + {P}_{n - 1 , M} \qquad ( 4 )$$

In the personal computer 4 illustrated in FIG. 1, at first, the pixel value P1,1, P1, 2, . . . , P1,M in the first line are determined by the formula (4). For example, by substituting n=1 into the formula (4) and further using P0 μM=0, the m-th pixel value in the main scanning direction among the pixel values in the first line is represented by the following formula (5).

$${P}_{1 , m} = {\sum }_{j = 1}^{m} {X}_{1 , j} \qquad ( 5 )$$

In this way, the pixel values P1,1, P1,2, . . . , P1,M in the first line are all determined.

The pixel values P2,1, P2,1, . . . , P2,M are obtained similarly by substituting n=2 into the formula (4) and using P1,M obtained by the decoding of the pixel values in the first line. For example, the m-th pixel value in the main scanning direction among the pixel values in the second line is expressed by the following formula (6).

$${P}_{2 , m} = {\sum }_{j = 1}^{m} ( {X}_{1 , j} - {X}_{2 , j} ) + {P}_{1 , M} \qquad ( 6 )$$

The pixel values in the third line and thereafter also are similarly determined by using the pixel values decoded by the formula (6) and the computation thereafter. In the personal computer 4 illustrated in FIG. 1, the decoding processing of data is performed in this way.

In the first differential encoding section 1510 in FIG. 2, image data is subjected to the two-dimensional differential encoding as described above. The data obtained by this two-dimensional differential encoding is inputted into the first offset section 1520 in FIG. 2, a predetermined offset value is added to each numerical value of the data, and the data is divided into a lower-order sub-plane D1L and a higher-order sub-plane D1H. Here, processing up to the division of the data will be described by using a specific image as an example.

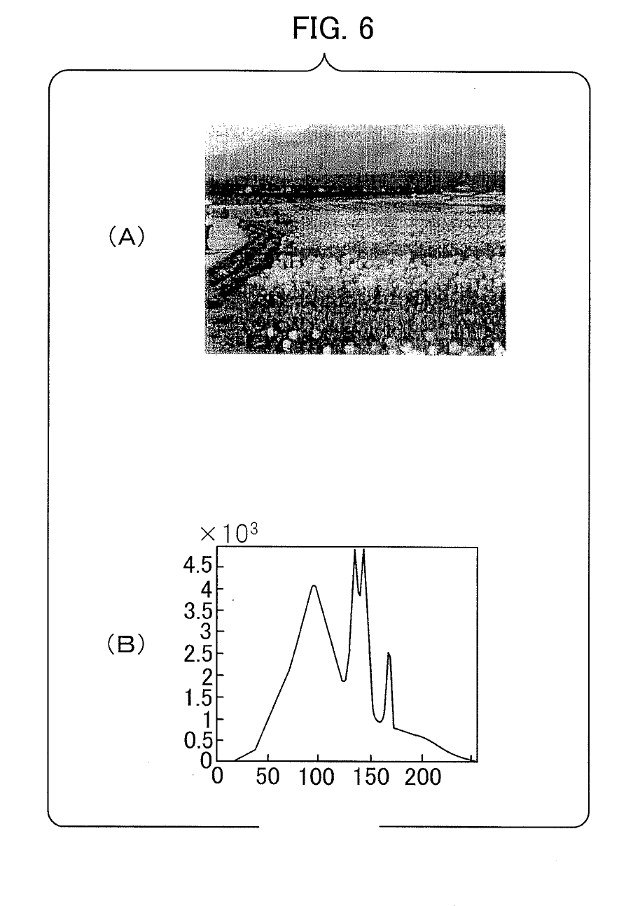

FIG. 6 is a diagram that illustrates an example of the image data.

In part (A) of FIG. 6, a monochrome scenic image is illustrated as an example of the image. In the present embodiment, there is used image data in which the color density in each pixel of such an image is expressed by an 8-bit numerical value. In part (B) of FIG. 6, there is illustrated a histogram of data values in the image data presenting the scenic image illustrated in part (A). The horizontal axis of this histogram represents the data value, while the vertical axis represents the number of pieces of data (the number of pixels). In a normal image, the width of the histogram is large, and peaks and valleys in the number of pieces of data appear, but it is extremely rare that an area where the number of pieces of data is “0” in the middle of the histogram is produced.

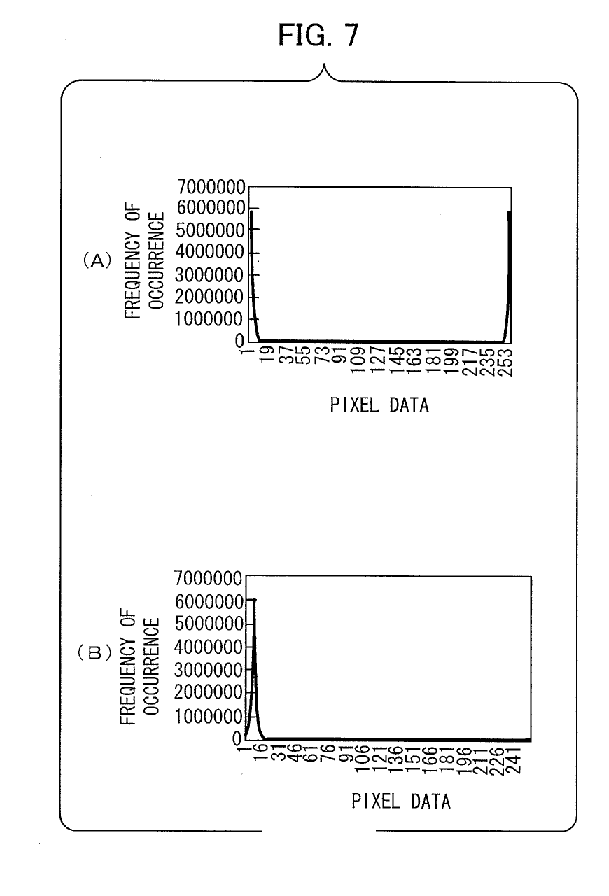

FIG. 7 is a diagram that illustrates an effect of the differential encoding and the offset applied to the image data.

In part (A) of FIG. 7, there is illustrated a histogram of data obtained by subjecting the image data illustrated in FIG. 6 to the differential encoding. The horizontal axis of this histogram represents the data value, while the vertical axis represents the frequency of occurrence. When the image data is subjected to the differential encoding described with reference to FIG. 4 and FIG. 5, the histogram of the data generally has a sharp peak at each of the minimum data value and the maximum data value as illustrated in part (A) of FIG. 7. And, when such data is offset, the histogram of the data has a sharp peak at an offset value as illustrated in part (B) of FIG. 7. In the present embodiment, “8” is used as the offset value, and as a result of the offset, the frequencies of the data values more than “16” become almost “0”.

The data whose histogram is transformed by the differential encoding and the offset in this way is divided into the lower-order sub-plane 1D1L and the higher-order sub-plane 1D1H by the first plane division section 1530 in FIG. 2.

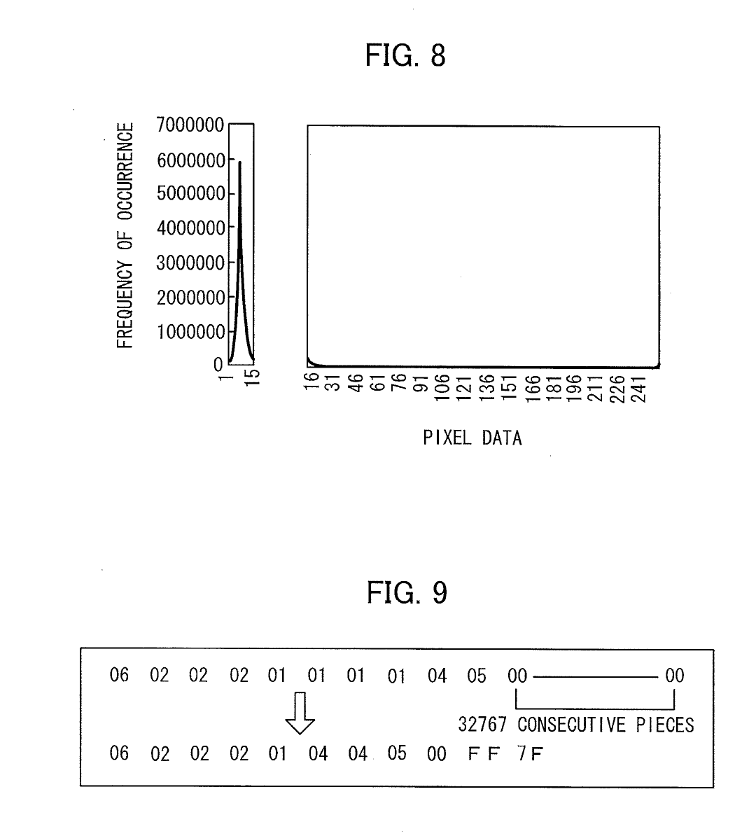

FIG. 8 is a diagram that explains an effect of the data division by the first plane division section 1530.

FIG. 8 illustrates a histogram obtained by dividing the histogram illustrated in part (B) of FIG. 7 between the data value “15” or smaller and the data value “16” or lager. The data division by the first plane division region 1530 in FIG. 2 produces an effect equivalent to this division of the histogram. In other words, in the present embodiment, each of 8-bit numerical vales of the data is divided into higher-order 4 bits and lower-order 4 bits, so that there are obtained the lower-order sub-plane 1D1L made up of a series of numerical values represented by the lower-order 4 bits and the higher-order sub-plane 1D1H made up of a series of numerical values represented by the higher-order 4 bits. Further, when it is interpreted that the 4-bit numerical values of the lower-order sub-plane 1D1L directly represent the numerical values from “0” to “15”, and the 4-bit numerical values of the higher-order sub-plane 1D1H represent 16 types of numerical values at 16 intervals from value “16” to value “256”, the histogram of the lower-order sub-plane 1D1L is about the same as the histogram shown on the left side in FIG. 8, and the histogram of the higher-order sub-plane 1D1H is about the same as the histogram illustrated on the right side in FIG. 8. However, in the histogram of the higher-order sub-plane 1D1H, a peak having a height equal to an area of the histogram shown on the left side in FIG. 8 is added to the data value “16” of the histogram illustrated on the right side in FIG. 8.

In the following, processing of the data after being divided into the higher-order sub-plane 1D1H and the lower-order sub-plane 1D1L will be described.

First, the processing applied to the higher-order sub-plane 1D1H will be described.

As apparent from the fact that the frequencies of occurrence of the pixels in the histogram shown on the right side in FIG. 8 are almost zero, it is expected that many of the numerical values of the higher-order sub-plane 1D1H are consecutive values near zero (“00” and “01” and “FF” in hexadecimal notation). For this reason, in order to compress the higher-order sub-plane 1D1H, it is effective to perform run-length encoding in which compression is performed by encoding identical consecutive numerical values, and the higher-order sub-plane 1D1H is inputted into the run-length encoding section 1551 that is one of the elements forming the first H-plane compression section 1550 illustrated in FIG. 2.

In the present embodiment, two continuous 4-bit numerical values of the higher-order sub-plane 1D1H are treated as a single 8-bit numerical value in the run-length encoding section 1551 for convenience of processing, and a series of numerical values from “00” to “FF” in hexadecimal notation are subjected to the following encoding processing.

In this encoding processing, only a particular numerical value of plural 8-bit numerical values is encoded. Therefore, in this run-length encoding section 1551, a numerical value targeted for the encoding processing (here, this numerical value is referred to as a “to-be-compressed numerical value”) and the number of consecutive values that are the to-be-compressed numerical values are detected among the received data.

In the present embodiment, for instance, three numerical values of “01”, “FF” and “00” are each used as the to-be-compressed numerical value.

FIG. 9 is a diagram to explain the encoding in the run-length encoding section 1551 illustrated in FIG. 2.

The upper line in FIG. 9 represents data of the higher-order sub-plane 1D1H, and the lower line represents data after being subjected to the encoding processing in the run-length encoding section 1551.

Here, as illustrated in the upper line in FIG. 9, the data made up of “06 02 02 02 01 01 01 01 04 05 00 . . . ” is assumed to be inputted from the run-length encoding section 1551. At this time, in the run-length encoding section 1551 in FIG. 2, there are detected: the head “06” as well as the next “02 02 02” as not being the to-be-compressed numerical values; the subsequent four consecutive pieces of “01” as being the to-be-compressed numerical values; and subsequently, after “04” and “05”, consecutive 32767 pieces of “00” as being the to-be-compressed numerical values.

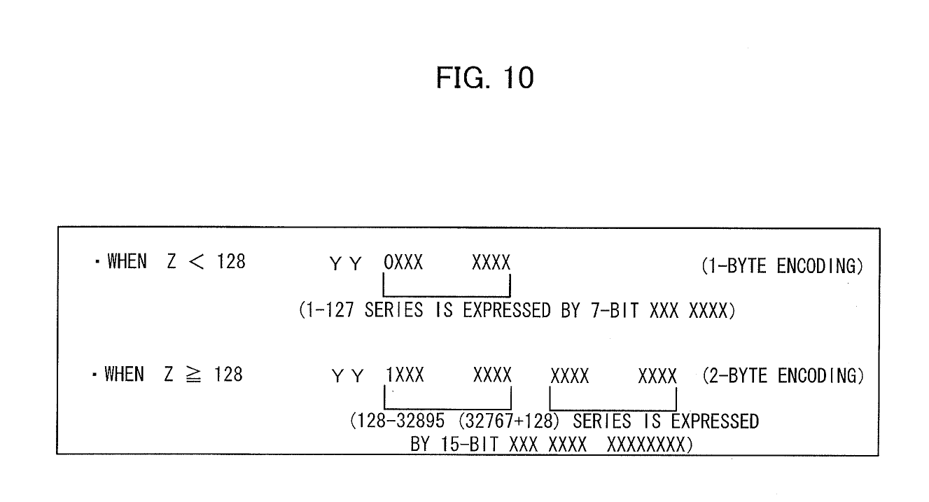

FIG. 10 is a diagram that illustrates an algorithm of the encoding that targets the to-be-compressed numerical values in the run-length encoding section.

In FIG. 10, Z represents the number of consecutive identical to-be-compressed numerical values. For example, in the upper line in FIG. 9, Z=4 for “01”, and Z=32,767 for “00”.

Further, in FIG. 10, “YY” represents the to-be-compressed numerical value in two-digit hexadecimal notation. Following “YY,” “0” or “1” is “0” or “1” expressed in 1 bit, and in “XXX XXXX . . . ” subsequent thereto, a single “X” represents 1 bit, and the value of Z is expressed by this “XXX XXXX . . . ”.

In other words, FIG. 10 means that when the to-be-compressed numerical value “YY” continues for Z<128 pieces, the first byte expresses the to-be-compressed numerical value “YY”, the first bit of the next one byte is “0”, and the subsequent 7 bits express the value of “Z”. Further, FIG. 10 means that when the to-be-compressed numerical value “YY” continues for Z³128 pieces, the first byte expresses the to-be-compressed numerical value “YY”, the expression covers the next 2 bytes (16 bits) by placing “1” at the first bit, and the subsequent 15 bits express the value of “Z”.

An example of the encoding illustrated in FIG. 9 will be described according to the rule illustrated in FIG. 10.

The head numerical value “06” of the data (upper line) of the higher-order sub-plane 1D1H inputted from the first plane division section 1530 in FIG. 2 is not the to-be-compressed numerical value and therefore, this “06” is directly outputted. Also, “02” of “02 02 02” subsequent to the head “06” is not the to-be-compressed numerical value and thus, these three “02” also are directly outputted. Subsequently, there are four consecutive pieces of the to-be-compressed numerical value “01” and therefore, these are encoded into “01 04”. The next “04” and “05” are not the to-be-compressed numerical values and thus, “04 05” is directly outputted.

Subsequently, there are 32767 consecutive pieces of “00” and thus, “00” is placed, 1 bit at the head of the next 1 byte is turned to be “1”, and the next 15 bits are used to express 32767+128, so that there is expressed the fact that there are 32767 consecutive pieces of “00” by using 3 bytes of “00 FF 7F”. In other words, the number of consecutive pieces 128 is expressed by “00 00” except the first bit “1”.

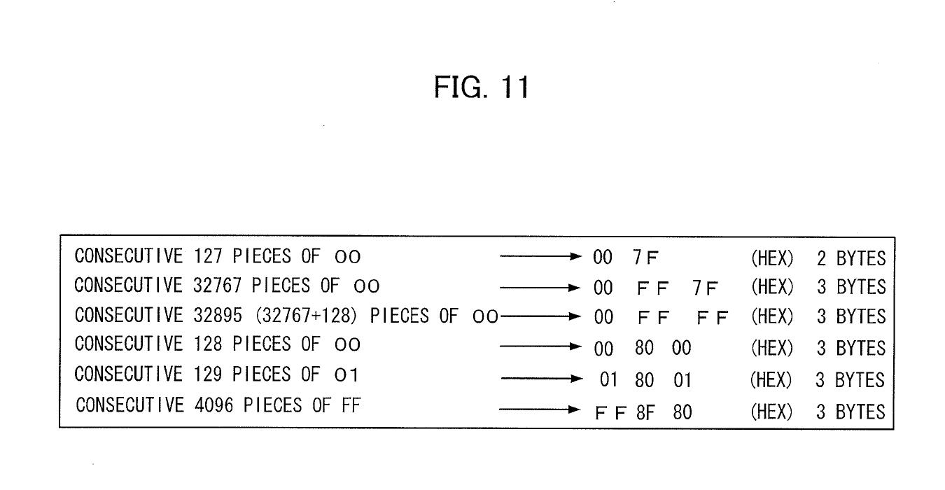

FIG. 11 is a diagram that illustrates an example of the encoding processing according to the number of consecutive pieces in the run-length encoding section 1551 in FIG. 2.

When there are 127 consecutive pieces of “00”, these are encoded into “00 7F” using 2 bytes.

When there are 32767 consecutive pieces of “00”, these are encoded into “00 FF 7F” using 3 bytes.

When there are 32895 consecutive pieces of “00”, these are encoded into “00 FF FF” using 3 bytes.

When there are 128 consecutive pieces of “00”, these are encoded into “00 80 00” using 3 bytes.

When there are 129 consecutive pieces of “01”, these are encoded into “01 80 01” using 3 bytes.

When there are 4096 consecutive pieces of “FF”, these are encoded into “FF 8F 80” using 3 bytes.

In the run-length encoding section 1551 illustrated in FIG. 2, the above-described encoding processing is performed.

According to the run-length encoding section 1551 of the present embodiment, the maximum compression ratio improves up to 3/32895=1/10965. Also, as described with reference to the histogram in FIG. 8, in the data of the higher-order sub-plane 1D1H targeted for the encoding processing by this run-length encoding section 1551, most of 4-bit numerical values are “0” expressing the data value “16”, and many of 8-bit numerical values made from the 4-bit numerical values also are “00” in hexadecimal notation. For this reason, high data compression is expected to be realized by the encoding processing in the run-length encoding section 1551.

The data after being subjected to the encoding processing by the run-length encoding section 1551 in the first H-plane compression section 1550 in FIG. 2 is subsequently inputted into the data scanning section 1552 and the Huffman encoding section 1553 of the first H-plane compression section 1550 in FIG. 2.

In this data scanning section 1552, first, the whole data outputted from the run-length encoding section 1551 is scanned, and the frequencies of occurrence of the data values are determined.

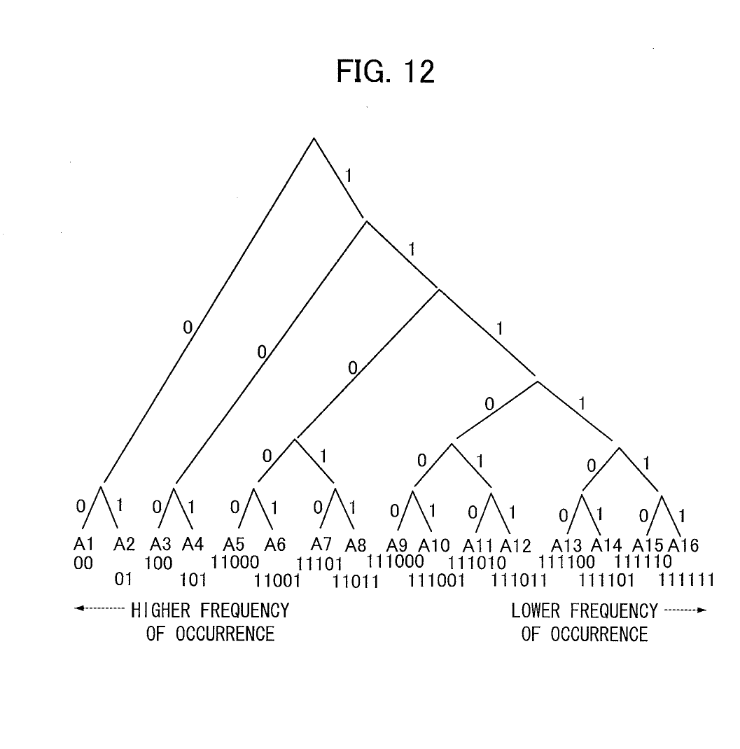

FIG. 12 is a diagram that illustrates an example of the result obtained by scanning of the data scanning section 1552.

Here, the frequency of occurrence of “A1” is the highest, followed by “A2”, “A3”, “A4”, and so on sequentially. Incidentally, these “A1”, “A2” and the like do not directly represent numerical values and are codes to express the numerical values. In other words, for example, “A1” expresses a numerical value “00”, and “A2” expresses a numerical value “FF”. Also, here, for the sake of simplicity, all the data values of the data sent from the run-length encoding section 1551 in FIG. 2 are assumed to be any of 16 numerical values from “A1” to “A16”. Further, in the data scanning section 1552, a code according to the frequency of occurrence is assigned to each of these 16 numerical values, and a Huffman table is created. In other words, a code “00” expressed in 2 bits is assigned to “A1” of the highest frequency of occurrence, and a code “01” expressed also in 2 bits is assigned to the next “A2”. Further, a code “100” and a code “101” each expressed in 3 bits are assigned to the next “A3” and “A4”, respectively, and each code expressed in 5 bits is assigned to each of the next “A5” to “A8”. Thereafter, similarly, a code expressed in the larger number of bits is assigned to the numerical value whose frequency of occurrence is lower.

FIG. 1 13 is a diagram that illustrates an example of the Huffman table.

This Huffman table is made to agree with FIG. 12. This is a correspondence table in which the numerical values are arranged so that the numerical values with higher frequencies of occurrence are replaced by the codes expressed in the smaller number of bits, and which shows correspondence between the numerical values before the encoding (before being replaced) and the numerical values after the encoding (after being replaced).

In the Huffman encoding section 1553 of the first H-plane compression section 1550 in FIG. 2, the numerical values of data are encoded in accordance with the above-described Huffman table, and as a result, many of the numerical values are replaced by the codes in the small number of bits, thereby realizing data compression.

FIG. 14 is a diagram that illustrates specific examples of the code string prepared in the Huffman table.

In each of the code strings illustrated in FIG. 14, a numerical value on the right side of “,” represents a bit length, and a binary code in the bit length aligned on the left side of the “,” represents an actual code. For example, the first code at the upper left in FIG. 14 is “11” in 2 bits, subsequently the second code is “011” in 3 bits, the third code is “101” in 3 bits, and the fourth code is “1010” in 4 bits. By using such a code string, the numerical values having higher frequencies of occurrence are replaced by the codes expressed in the smaller number of bits.

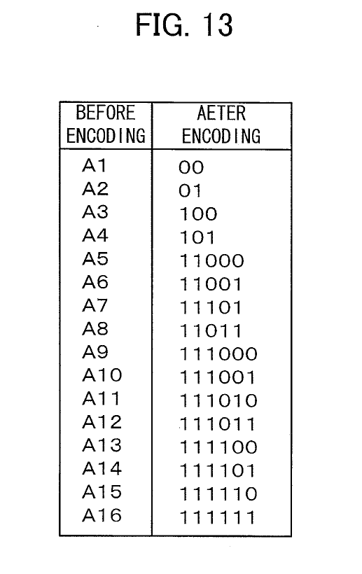

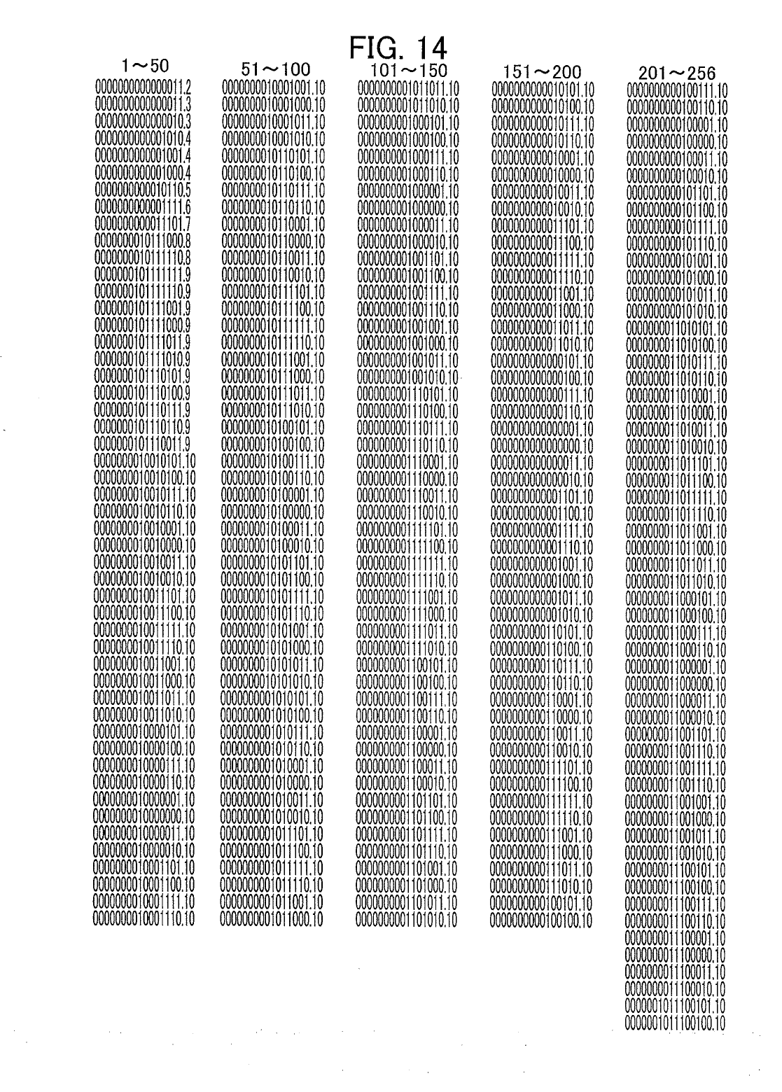

By the processing described above with reference to FIG. 9 through FIG. 14, the higher-order sub-plane 1D1H inputted into the first H-plane compression section 1550 in FIG. 2 is subjected to the encoding by the run-length encoding section 1551 and the encoding by the Huffman encoding section 1553, thereby being compressed using a high compression ratio and resulting in the higher-order compressed data 1D2H.

Next, the processing applied to the lower-order sub-plane 1D1L will be described. The lower-order sub-plane 1D1L obtained as a result of the division by the first plane division section 1530 is subjected to the Huffman encoding processing described with reference to FIG. 12 through FIG. 14 in the Huffman encoding section 1541 of the first L-plane compression section 1540. The lower-order sub-plane 1D1L after the Huffman encoding is outputted from the first L-plane compression section 1540 as lower-order compressed data D2L. Incidentally, as mentioned earlier, when the high-speed mode is designated by the user, the lower-order sub-plane 1D1L is outputted from the first L-plane compression section 1540 while the Huffman encoding processing by the Huffman encoding section 1541 is omitted.

In the reversible compression by the first H-plane compression section 1550 and the first L-plane compression section 1540, the numerical values of data having a sharper peak that appears in the histogram of the data offset by the first offset section 1520 in FIG. 2 are concentrated around the offset value. Therefore, high compression is expected by the run-length encoding and the Huffman encoding.

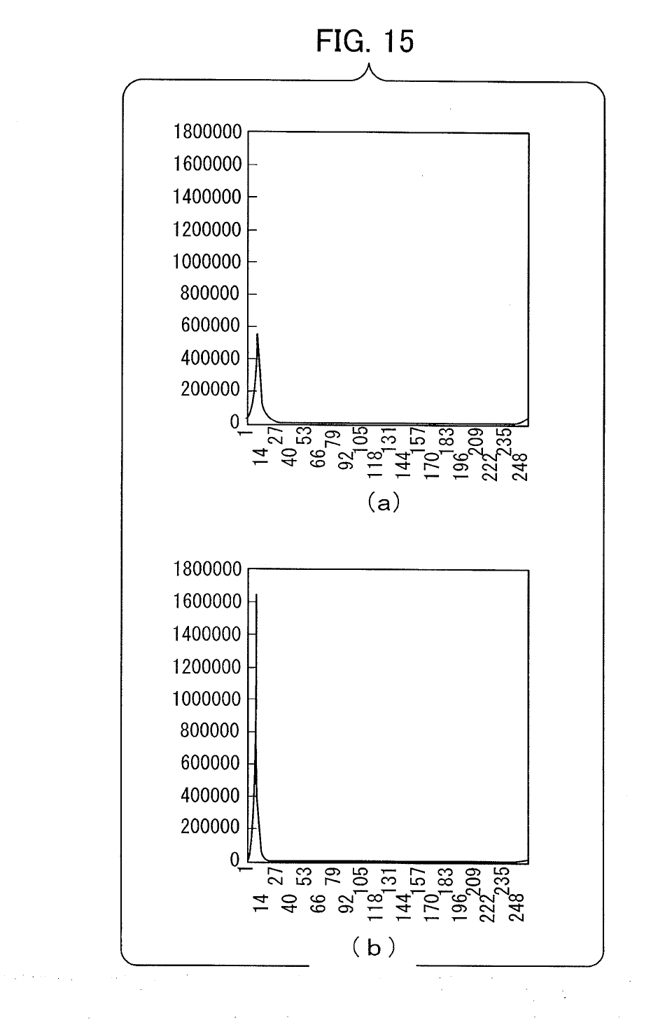

FIG. 15 illustrates two histograms showing peaks different in sharpness.

Part (A) of FIG. 15 illustrates an example of the histogram of data in which the degree of concentration around an offset value is low, while part (B) of FIG. 15 illustrates an example of the histogram in which the degree of concentration around an offset value is high. When the data in each of these two types of histogram is subjected to the run-length encoding or the Huffman encoding described above, the data in part (B) of FIG. 15 has a higher degree of concentration around the offset value than that of the data in part (A) of FIG. 15 and thus, higher compression (i.e., a smaller value of a compression ratio) can be expected for the data in part (B) of FIG. 15.

In this way, a feature showing how easy to be subjected to the run-length encoding or the Huffman encoding appears in the histogram of the data after the offset. Therefore, even in a stage before the run-length encoding and the Huffman encoding are actually performed, it is possible to predict what degree of compression ratio can be obtained by these encoding processing. In the present embodiment, by the first compression ratio estimation section 1570 within the reversible compression section 500A in FIG. 2, analysis of the histogram of data after the offset is performed, and a compression ratio of the reversible compression processing by the reversible compression section 500A is estimated.

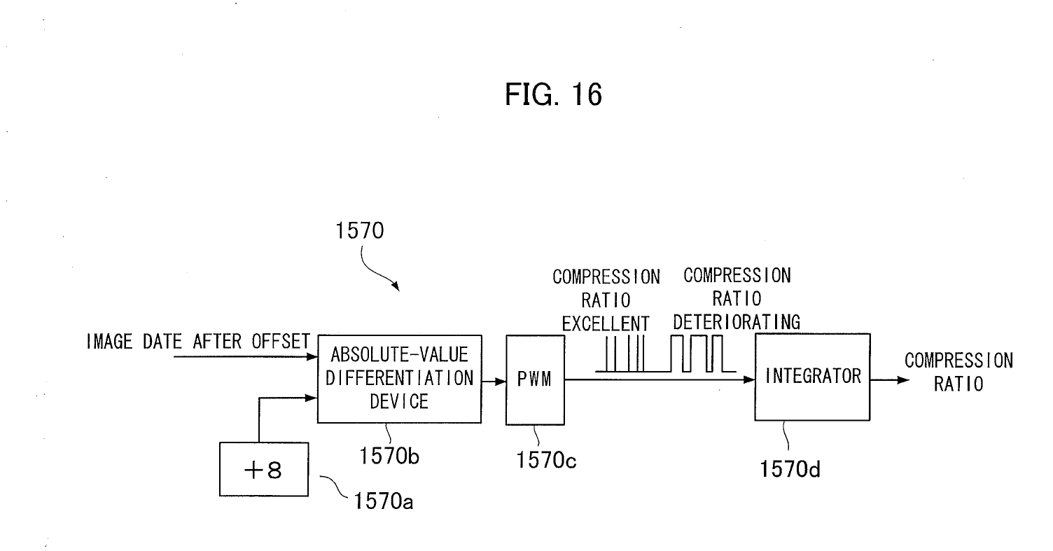

FIG. 16 is a schematic block diagram that illustrates a structure of the first compression ratio estimation section 1570 in FIG. 2.

At first, post-offset data inputted into the first compression ratio estimation section 1570 is inputted into the absolute-value difference device 1570b. Reference data 1570a also is inputted into this absolute-value difference device 1570b. In the reference data 1570a, the number of numerical values of the data is the same as that of the numerical values of the post-offset data and all the data values are +8. The absolute value difference device 1570b calculates an absolute value of the difference between the numerical values of the post-offset data and the numerical values of the reference data 1570a. In other words, in the absolute-value difference device 1570b, the absolute value of the difference is obtained by subtracting 8 from each of the numerical values of the post-offset data. Next, data formed by a series of pieces of such absolute data of the difference is inputted into the pulse-width modulator (Pulse Width Modulation device) 1570c, and there is generated a waveform of a series of pulse waves in which the size of each numerical value of this data is represented as a pulse width. Here, “+8” that is the numerical value of the reference data 1570a is the numerical value of the offset value as described above. Therefore, in the pulse width modulator 1570c, a waveform with many pulse waves each having a large pulse width is generated from the data expected to have a large compression ratio value because of its low concentration degree on the offset value like the data providing the histogram in part (A) of FIG. 15, whereas a waveform with many pulse waves each having a small pulse width is generated from the data expected to have a small compression ratio value because of its high concentration degree on the offset value like the data providing the histogram in part (B) of FIG. 15. This waveform is inputted into the integrator 1570d where integration processing (area calculation of a region surrounded by the lateral axis and the waveform) is performed. The waveform with a larger number of pulse waves whose pulse width is small results in a smaller integral obtained by the integrator 1570d, and it is possible to estimate, based on this integral, to what extent the compression ratio will be. In the present embodiment, this integral is an estimated value of the compression ratio.

In the first compression ratio estimation section 1570, the thus-obtained estimated value of the compression ratio is compared with the first target compression ratio that is inputted beforehand into the first compression ratio estimation section 1570, so that it is determined whether the estimated value of the compression ratio is equal to or lower than this first target compression ratio. As mentioned earlier, this first target compression ratio is a compression ratio that provides an upper-limit threshold for sending the image data after being compressed to the personal computer 4 in a short time to such an extent that when the user views an image on the display screen of the personal computer 4 illustrated in FIG. 1, the user does not feel the display of the image as being slow. Further, this estimated value is a compression ratio corresponding to the limit of the amount of output data in the output switching section 501. The result of the determination by the first compression ratio estimation section 1570 is outputted to the output switching section 501 in FIG. 2.

Next, the compression processing of in the irreversible compression processing section 500B in FIG. 2 will be described.

As described earlier, the data same as the image data D0 inputted into the reversible compression processing section 500A is inputted into the irreversible compression processing section 500B in FIG. 2. When the image data D0 is inputted into the reversible compression processing section 500B, at first, the data is inputted into the thinning processing section 2505 where the data is divided into the pixel data of TRUE pixels targeted for the reversible compression processing and the pixel data of FAKE pixels targeted for the irreversible compression processing.

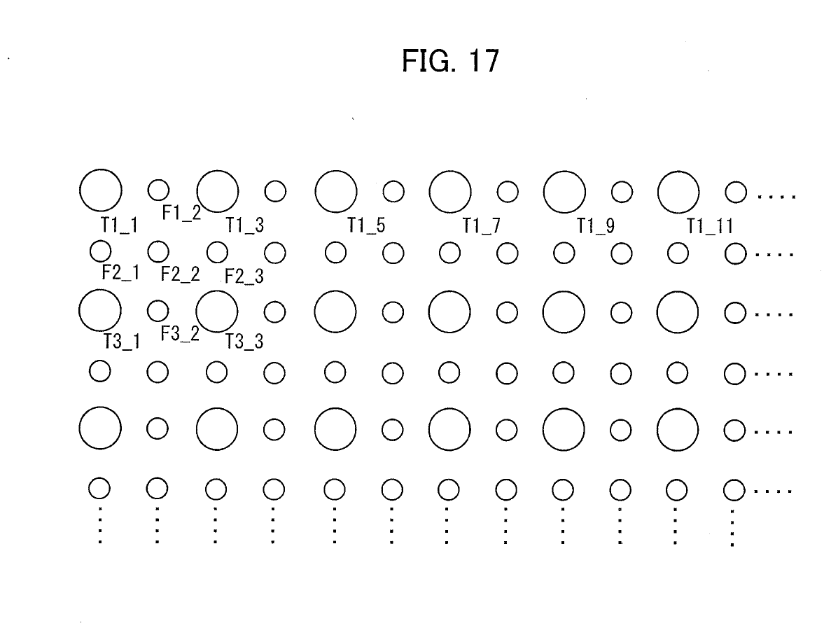

FIG. 17 is a diagram that illustrates a concept of the thinning processing performed by the thinning processing section 2505 in FIG. 2.

FIG. 17 also illustrates the data structure of the image data D0. The data structure of the image data D0 illustrated in FIG. 17 is, actually, the same as the data structure illustrated in FIG. 3. In FIG. 17 however, the data structure is illustrated in a form different from that of FIG. 3 to show the concept of the thinning processing.

In FIG. 17, the lateral direction of FIG. 17 corresponds to the main scanning direction in FIG. 3, and the direction orthogonal to the main scanning direction is the sub-scanning direction. As described earlier, a row in which pixels are aligned along the main scanning direction is referred as the line, and pixels for the six lines are illustrated here. In FIG. 17, the position of each pixel is expressed by a subscript added to codes T and F each representing a pixel value. For example, in the third line, subscripts of 3_1, 3_2, 3_3, 3_4 and so on are sequentially added to the respective pixel values aligned in the main scanning direction.

The image data made up of the pixel values aligned in this manner is inputted into the thinning processing section 2505 of the compression processing section 500 illustrated in FIG. 2, and the thinning processing section 2505 classifies the respective pixels into the TRUE pixels and the FAKE pixels. The TRUE pixels among the pixels illustrated in FIG. 17 are each represented by the code T, whereas the FAKE pixels among the pixels illustrated in FIG. 17 are each represented by the code F. The TRUE pixels are periodically taken out from the aligned pixels, and this figure illustrates that in every other line (odd-numbered line) along the sub-scanning direction, every other TRUE pixel (odd-numbered pixel) along the main scanning direction is taken out as the TRUE pixel. As a result, the TRUE pixels are equivalent to pixels of an image whose resolution is deteriorated to a half of the original resolution, and the pixels corresponding to a quarter of the original image data are taken out. The TRUE pixels taken out in this manner form TRUE pixel data made up of a series of such TRUE pixels, and like the original image data, the TRUE pixel data has such a structure that the pixels are aligned in the main scanning direction and the sub-scanning direction. Also, the FAKE pixels left by taking out the TRUE pixels form FAKE pixel data made up of a series of such FAKE pixels. This FAKE pixel data is targeted for the irreversible compression processing, while the TRUE pixel data is targeted for the reversible compression processing.

The TRUE pixel data is subjected to the reversible compression processing that is similar to the above-described reversible compression processing in the reversible compression processing section 500A, by the second differential encoding section 2510, the second offset section 2520, the second plane division section 2530, the second L-plane compression section 2540 and the second H-plane compression section 2550 in the irreversible compression processing section 500B. The contents of this processing are the same as those of the processing described above with reference to FIG. 3 through FIG. 14 and thus will not be described. As a result of the reversible compression processing applied to the TRUE pixel data, the lower-order compressed data 2D2L is outputted from the second L-plane compression section 2540, and the higher compressed data 2D2H is outputted from the second H-plane compression section 2550. Here, in the irreversible compression processing section 500B, the second compression ratio estimation section 2570 having a structure similar to that of the first compression ratio estimation section 1570 is provided. For the data offset by the second offset section 2520, an estimated value of the compression ratio of the reversible compression processing for the TRUE pixel data is determined by the second compression ratio estimation section 2570 by using the method same as the estimation method described above with reference to FIG. 16. In the second compression ratio estimation section 2570, as described above, a reversible compression processing component of the estimated value of the compression ratio in the entire irreversible compression processing section 500B is obtained by multiplying the estimated value of the compression ratio in this reversible compression processing by the ratio (thinning-out rate) of the TRUE pixels to all the pixels. Further, in the second compression ratio estimation section 2570, there is stored a value (constant) of the irreversible compression processing component of the estimated value of the compression ratio in the entire irreversible compression processing section 500B. This value is obtained by multiplying the compression ratio in the FAKE-pixel-data compression section 2560, which is a compression ratio when all the FAKE pixels are virtually subjected to the 4-bit encoding by the FAKE-pixel-data compression section 2560 and the run-length encoding processing and the Huffman encoding are not performed, by the ratio of the FAKE pixels to all the pixels. By adding the above reversible compression processing component to this value, the estimated value of the compression ratio in the entire irreversible compression processing section 500B is obtained. In the second compression ratio estimation section 2570, the thus-obtained estimated value of the compression ratio in the entire irreversible compression processing section 500B is compared with the second target compression ratio inputted beforehand into the second compression ratio estimation section 2570, so that whether the estimated value of the compression ratio is equal to or lower than the second target compression ratio is determined. As described earlier, this second target compression ratio is a compression ratio that provides the upper-limit threshold to suppress the entire data amount to a level equal to or below the limit of the amount of output data in the output switching section 501, so that the entire data amount will not be enormous even if the image data after being subjected to the irreversible compression processing and the environment information data are combined. The value of the second target compression ratio is smaller than the value of the first target compression ratio.

Next, the irreversible compression processing for the FAKE pixel data will be described. The FAKE pixel data obtained by the thinning processing section 2505 is inputted into the FAKE-pixel-data compression section 2560, and the bit reducing section 2561 in the FAKE-pixel-data compression section 2560 encodes the FAKE pixel data into 4 bits or 1 bit, depending on whether or not the FAKE pixel data is the pixel data at an edge portion. Whether the FAKE pixel data is the pixel data at an edge portion or not is determined by the edge detection section 2525 in FIG. 2, based on differential data after the offset by the second offset section 2520.

In the following, how the FAKE pixel data is encoded will be described.

When the pixel value of the TRUE pixel illustrated in FIG. 17 is expressed by Tn_k, the pixel value of the FAKE pixel adjacent to this TRUE pixel is expressed by Fn_k+1 and thereafter, Fn+1_k, Fn+1_k+1 and so on. The pixel value of another TRUE pixel at a position over the FAKE pixel adjacent to the TRUE pixel mentioned first is expressed by Tn_k+2 and thereafter, Tn+2_k, Tn+2_k+2 and so on. In the edge detection section 2525, when a differential value obtained by the two-dimensional differential encoding processing from these four TRUE pixels' pixel values Tn_k, Tn_k+2, Tn+2_k and Tn+2_k+2 (here, this is not a differential value expressed by the numerical value from “00” to “FF” in hexadecimal notation as described above, but this is a differential value obtained by acquiring directly a difference of the pixel values and expressed in decimal notation) belongs to a domain bellow (−L) or a domain equal to or above (+L) defined by using a positive integer-value threshold parameter L set in the edge detection section 2525, the above-mentioned three FAKE pixels' pixel values Fn_k+1, Fn+1_k and Fn+1_k+1 are determined to be the pixel values at an edge portion and each encoded into a 4-bit code starting from “1” by the reducing section 2561.

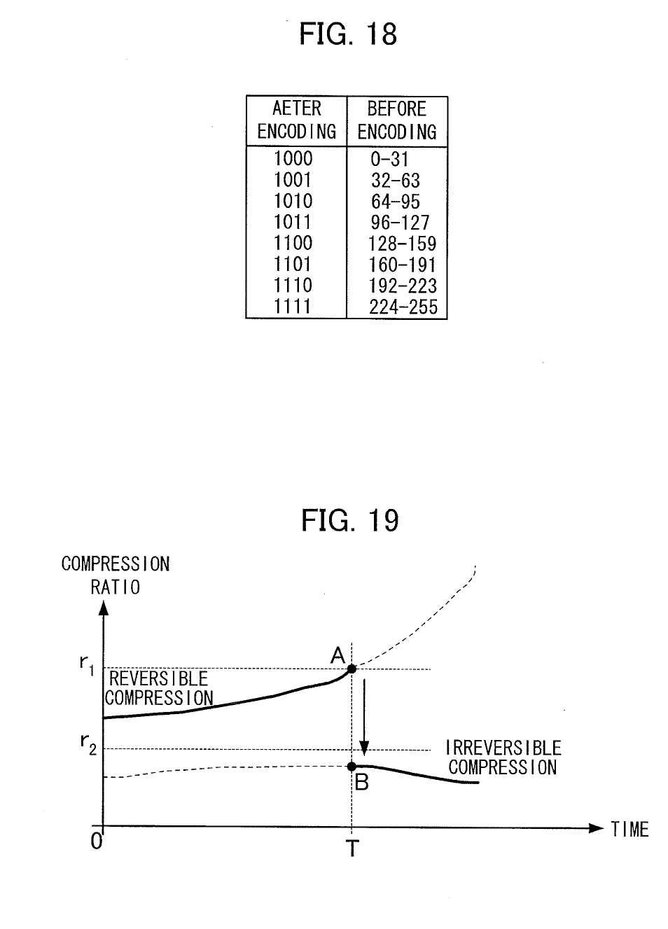

FIG. 18 is a diagram that illustrates an encoding method of encoding into the 4-bit code.

In this encoding method, the pixel value of the FAKE pixel is encoded into a code of “1000”-“1111” by cutting off lower-order five digits of an 8-bit value that represents the pixel value and adding “1” to the head of the remaining higher-order three digits. Thus, as illustrated in the list of this figure, among the numerical values “0”-“255” before the encoding, the numerical values “0”-“31” are encoded into “1000”, and the numerical values “22”-“63” are encoded into “1001”. Similarly, the numerical values “64”-“95”, “96”-“127”, “128”-“159”, “160”-“191”, “192”-“223” and “224”-“255” are encoded into “1010”, “1011”, “1100”, “1101”, “1110” and “1111”, respectively. Such an encoding method is realized by an extremely simple process in digits of a bit value are cut off. By such encoding into the 4-bit code, the information on the original image is maintained to some extent, which avoids deterioration of the image quality.

In the edge detection section 2525, when the differential value obtained from the above-mentioned four TRUE pixels' pixel values Tn_k, Tn_k+2, Tn+2_k and Tn+2_k+2 by the two-dimensional differential encoding processing belongs to a domain of not less than (−L) and not more than (+L), the above-mentioned three FAKE pixels' pixel values Fn_k+1, Fn+1_k and Fn+1_k+1 are determined not to be the pixel values at an edge portion and encoded into a 1-bit code “0” in the bit reducing section 2561.

Here, the threshold parameter L that provides a criterion for the determination of the edge portion is a parameter set in the edge detection section 2525 by the parameter setting section 2580. When a determination result obtained by the second compression ratio estimation section 2570 indicates that the estimated value of the compression ratio is beyond the second target compression ratio, the parameter setting section 2580 reduces the number of FAKE pixels determined to be at an edge portion, by changing the value of the threshold parameter L currently set in the edge detection section 2525 to a larger value thereby making the condition for being at an edge portion severe. As a result, the method of the compression processing in the irreversible compression processing section 500B shifts to compression processing in which the compression ratio is smaller and the compression is high. On the other hand, when the determination result obtained by of the second compression ratio estimation section 2570 indicates that the estimated value of the compression ratio is equal to or less than the second target compression ratio, the parameter setting section 2580 increases the number of FAKE pixels determined to be at an edge portion, by changing the value of the threshold parameter L currently set in the edge detection section 2525 to a smaller value according to the size of a difference between the estimated value of the compression ratio and the second target compression ratio thereby loosening the condition for being at an edge portion. As a result, the method of the compression processing in the irreversible compression processing section 500B shifts to compression processing in which the value of the compression ratio is maintained to be equal to or lower than the second target compression ratio so that the compression is not excessive, thereby avoiding deterioration in the image quality.

The data replaced with the 1-bit or 4-bit code is subjected by the run-length encoding section 2562 and the Huffman encoding section 2563 to the processing quite same as the above-described processing in the first H-plane compression section 1550. Here, the FAKE-pixel-data compression section 2560 also includes a data scanning section that operates like the data scanning section 1552 of the first H-plane compression section 1550, but its illustration is omitted in FIG. 2. The FAKE pixel data after being subjected to the run-length encoding processing and the Huffman encoding processing is outputted from the FAKE-pixel-data compression section 2560 as the irreversibly compressed data 2D3.

A group made up of the lower-order compressed data 2D2L outputted by the second L-plane compression section 2540, the higher-order compressed data 2D2H outputted by the second H-plane compression section 2550 and the irreversibly compressed data 2D3 forms the compressed data obtained by subjecting the original image data to the irreversible compression processing in the irreversible compression processing section 500B. This compressed data is inputted into the output switching section 501.

When the estimated value of the compression ratio of the reversible compression processing by the reversible compression processing section 500A is equal to or lower than the above-described first target compression ratio, the output switching section 501 transmits the image data after being subjected to the reversible compression processing by the reversible compression processing section 500A to the personal computer 4 in FIG. 1 through the USB cable. On the other hand, when the estimated value of the compression ratio of the reversible compression processing by the reversible compression processing section 500A is above the first target compression ratio, the output switching section 501 adds the above-described environment information data to the image data after being subjected to irreversible compression processing by the irreversible compression processing section 500A to the reversible compression processing, and then transmits the image data to the personal computer 4.

FIG. 19 illustrates how the estimated value of the compression ratio of the data transmitted to the personal computer 4 by the output switching section 501 in FIG. 2 changes with the passage of time.

FIG. 19 illustrates an example of the change in time of the estimated value of the compression ratio of the data outputted by the output switching section 501 in FIG. 2. In FIG. 19, an upper graph indicates a change in time of the estimated value of the compression ratio of the data after being subjected to the irreversible compression processing by the reversible compression processing section 500A in FIG. 2, while a lower graph indicates a change in time of the estimated value of the compression ratio of the data after being subjected to the irreversible compression processing by the irreversible compression processing section 500B. In each of these upper and lower graphs, the estimated value of the compression ratio of the data transmitted to the personal computer 4 by the output switching section 501 in FIG. 2 is indicated by a thick solid line. As illustrated in FIG. 19, the data transmitted to the personal computer 4 is the data being subjected to the reversible compression processing by the reversible compression processing section 500A up to a time T, and becomes the data being subjected to the irreversible compression processing by the irreversible compression processing section 500B after the time T. Here, as to the compression ratio in the vertical axis, an upper compression ratio r1 is the first target compression ratio, and a lower compression ratio r2 is the second target compression ratio. In the example illustrated in FIG. 19, the estimated value of the compression ratio of the data being subjected to the reversible compression processing by the reversible compression processing section 500A reaches the first target compression ratio at the time T after monotonously increasing, and the degree of compression deteriorates after crossing the time T. For this reason, the output switching section 501 in FIG. 2 transmits the reversibly compressed data processed by the reversible compression processing section 500A and having no deterioration in the image quality to the personal computer 4 before the time T, and when this estimated value of the compression ratio of the data reaches the first target compression ratio at the time T, the output switching section 501 switches the data transmitted to the personal computer 4 to the irreversibly compressed data processed by the irreversible compression processing section 500B, having a large degree of compression and transmitted in a short time. As a result of this data switching, the compression value (estimated value) of the data transmitted to the personal computer 4 shifts from a coordinate point A in the graph (upper graph) of the compression ratio of the data being subjected to the reversible compression processing to a coordinate point B in the graph (lower graph) of the compression ratio of the data being subjected to the irreversible compression processing.

In the compression processing section 500 in FIG. 2, by performing the switching of the data in this way, suppression of deterioration in image quality as much as possible and reduction in the transmission time as much as possible are better balanced.

Further, as described above, the compression ratio of the data being subjected to the irreversible compression processing by the irreversible compression processing section 500B is maintained to be equal to or lower than the second target compression ratio by the parameter setting section 2580 in FIG. 2. Therefore, the amount of the entire data, in which the data being subjected to the irreversible compression processing is combined with the above-described environment information data, is suppressed to a sufficiently small value.

In the personal computer 4, the image data that has been transmitted thereto is subjected to the data decoding processing, and the image is displayed on the display screen of the personal computer 4. Incidentally, in this decoding processing, as to the irreversibly compressed FAKE pixel data, at the time of decompression, decompression processing is performed by quantizing the FAKE pixel data encoded into 4 bits into pixel data of eight phases, and by applying an interpolation calculation based on the pixel data of the peripheral TRUE pixel to the FAKE pixel data encoded into 1 bit. When an image is displayed based on the data being subjected to the irreversible compression processing by the irreversible compression processing section 500B, the image in which its image quality is slightly deteriorated because of the irreversible compression processing is displayed. However, in this case, based on the environment information data in the transmitted data, information at the time of shooting such as voice around a photographed place, a temperature, wind velocity, humidity and atmospheric pressure at the time of shooting is displayed on the display screen together with the image. As a result, the user can also obtain information other than the image.

In the above description, the shooting is performed by the USB camera 2. However, the present invention may employ a digital camera provided with a moving-image function, in place of the USB camera 2.

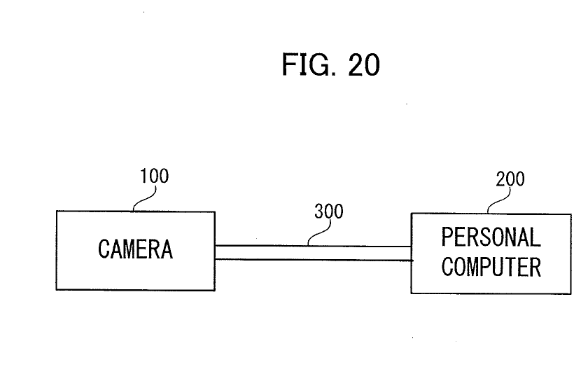

FIG. 20 is a functional block diagram of a camera system to which another embodiment of the present invention is applied.

The camera system in FIG. 20 includes a digital camera 100 and a personal computer 200. In this camera system, image data representing a shot image is generated as a result of shooting performed by using the digital camera 100, and the generated image data is subjected to compression processing and then transmitted from the digital camera 100 to the personal computer 200 via a USB cable 300, and an image is displayed on a display screen (not illustrated) of the personal computer 200. Here, the digital camera 100 has a moving-image shooting function, in addition to a still-image shooting function. In the camera system in FIG. 20, mainly, moving-image shooting is performed by the digital camera 100, and a moving image obtained by the shooting is displayed in approximately real time on the display screen of the personal computer 200.

In the camera system in FIG. 20, the digital camera 100 operates as one embodiment of the data compression apparatus of the present invention and as one embodiment of the image-taking apparatus of the present invention. This digital camera 100 will be described below.

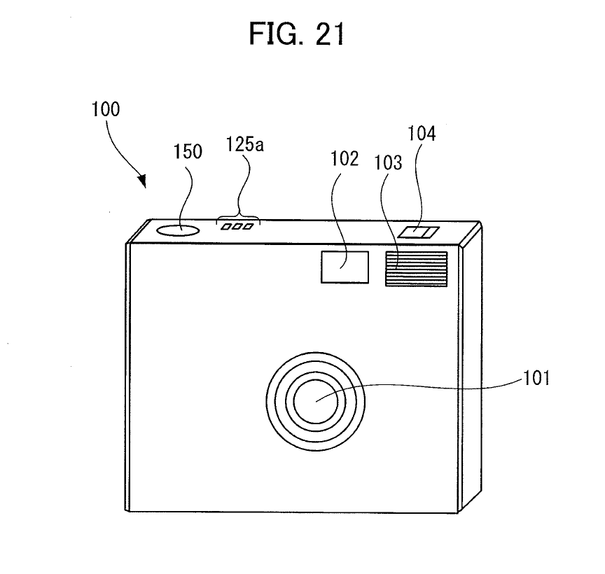

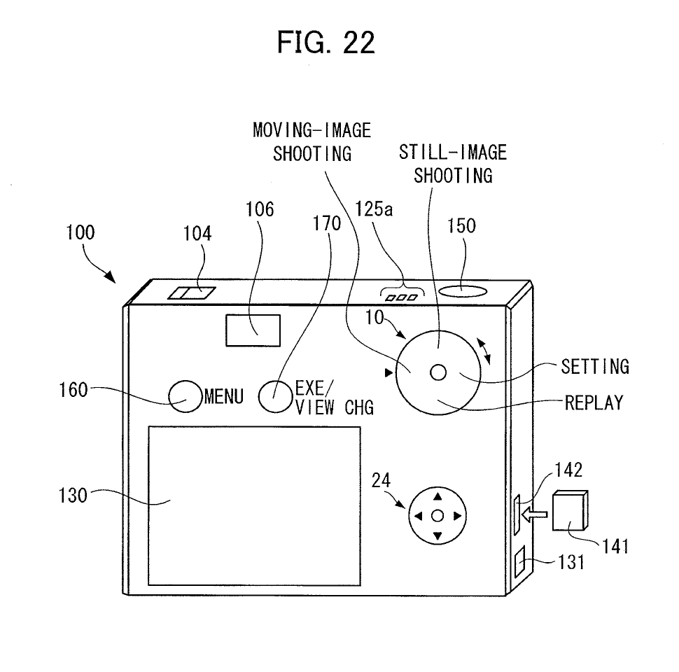

FIG. 21 is an external perspective diagram of the digital camera 100 in FIG. 20 when viewed obliquely from its front face, and FIG. 22 is an external perspective diagram of the digital camera 100 when viewed obliquely from its back face.

As illustrated in FIG. 21, the digital camera 100 includes a shooting lens 101 provided at the center of the front face, and further includes an optical finder objective window 102 and a flash emitting section 103 provided on an upper part of the front face. Furthermore, on a top surface of the digital camera 100, there are provided a sliding type of power switch 104, a release button 150 used by a user to instruct shooting, and a mouthpiece 125a having plural holes for transmitting the sound to a microphone (not illustrated in FIG. 21 and FIG. 22) disposed inside the digital camera 100.

Moreover, as illustrated in FIG. 22, on the back face of the digital camera 100, there are provided an optical finder ocular window 106, a menu button 160, an execution/view-changing switch 170, an image display section 130, a cross key 24 and a mode dial 10. The mode dial 10 is capable of rotating in either direction indicated by a double-headed arrow in the figure. The user can select, by operating the mode dial 10, a desired mode from among four operation modes of the digital camera 100, namely, a replay mode represented by “REPLAY”, an operation setting mode represented by “SETTING”, a still-image shooting mode represented by “STILL-IMAGE SHOOTING”, and a moving-image shooting mode represented by “MOVING-IMAGE SHOOTING”. This figure illustrates a state in which “MOVING-IMAGE SHOOTING” is selected. Further, on a flank of the digital camera 100, there are provided: a USB connector 131 into which a USB terminal of the USB cable is to be inserted when data is exchanged with the personal computer 200 in FIG. 20 via the USB cable 300; and a memory card slot 142 into which a memory card 141 that stores various kinds of data including image data is to be inserted.

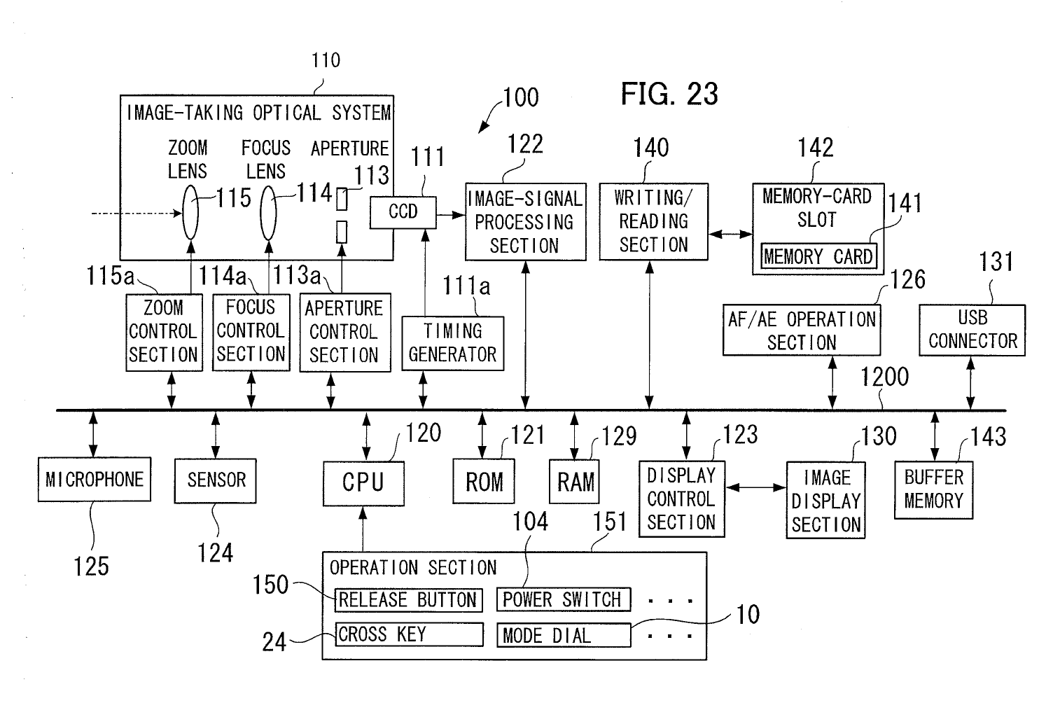

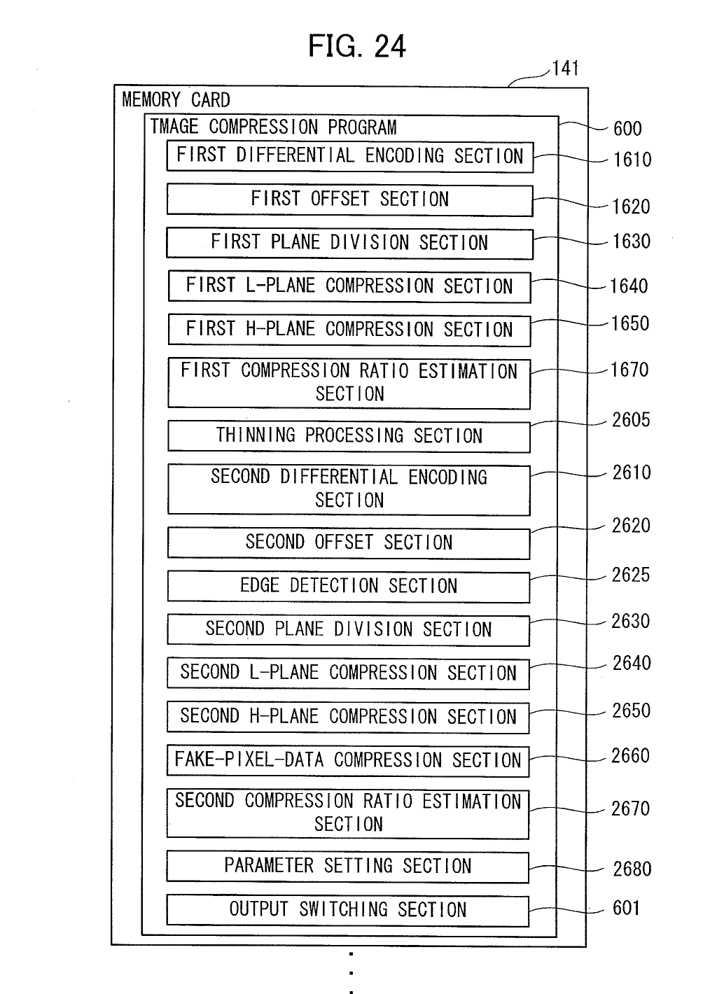

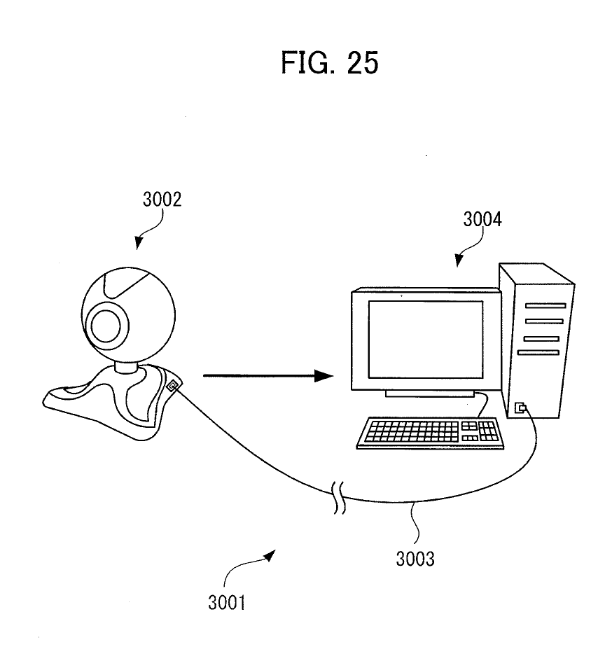

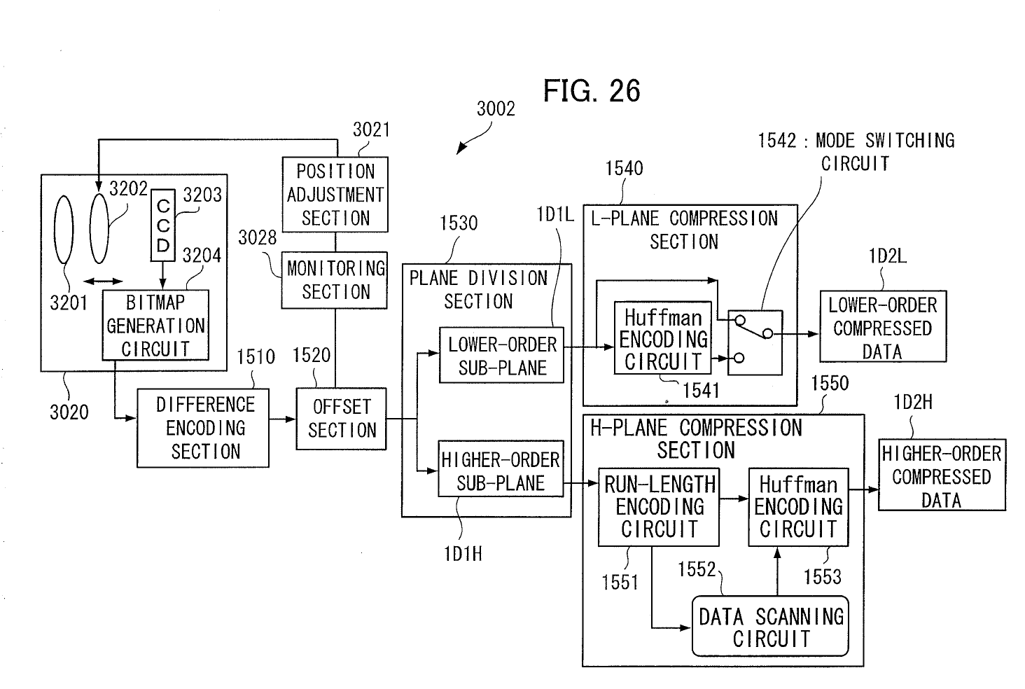

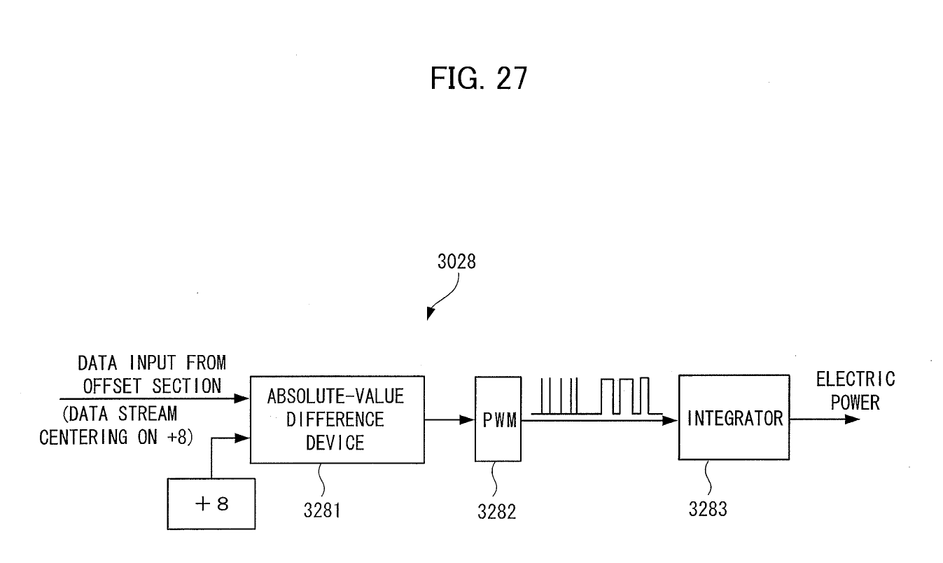

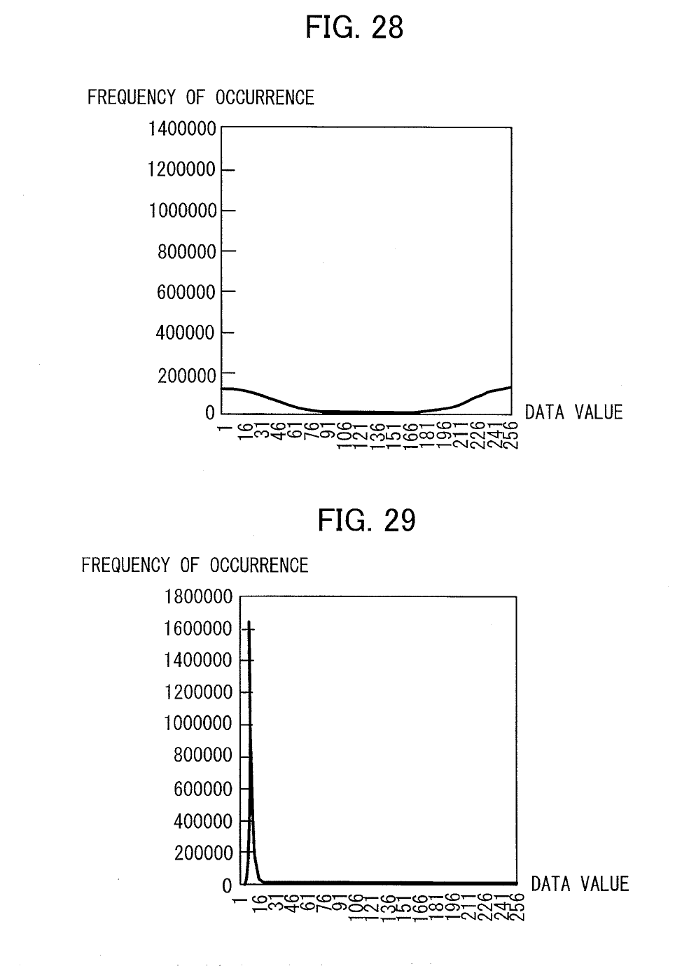

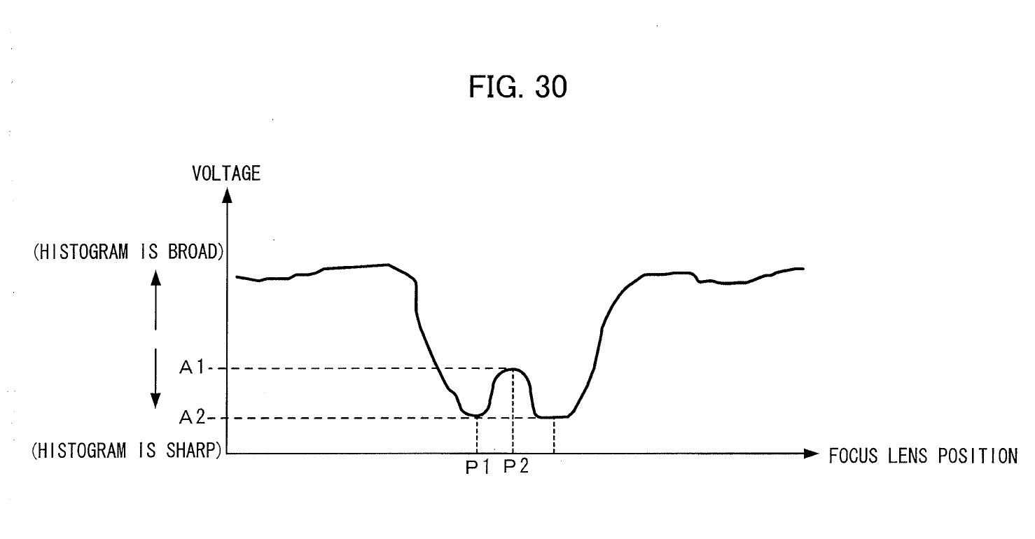

FIG. 23 is a schematic block diagram of the digital camera whose external appearance is illustrated in FIG. 21 and FIG. 22.

This digital camera 100 includes an image-taking optical system 110 having various kinds of lenses such as a focus lens 114 for focus adjustment and a zoom lens 115 for optical zooming, and an aperture 113 for adjusting the amount of light. Basically, an image-taking optical system includes plural lenses, at least one of these plural lenses is involved in the focus adjustment to a large degree, and relative positions among these lenses are related to a focal length. However, in FIG. 23, the lenses related to the change of the focal length are schematically illustrated as the zoom lens 115 and similarly, the lenses related to the focus adjustment are schematically illustrated as the focus lens 114. Further, there are also provided a focus control section 114a, a zoom control section 115a and an aperture control section 113a for driving the focus lens 114, the zoom lens 115 and the aperture 113, respectively. The aperture control section 113a adjusts exposure by controlling the aperture 113. The zoom control section 115a serves to change the magnification of optical zooming by moving the zoom lens 115. The focus control section 114a serves to change the contrast of a field and place the focus lens 114 at a focus position determined based on the state of the change in the contrast, by moving the focus lens 114 from a position corresponding to the farthest point of a subject distance to a position corresponding to a close point of the subject distance when an autofocus function of the digital camera 100 is operated. The digital camera 100 includes an AF/AE operation section 126 that calculates the amount of exposure and detects the contrast. The AF/AE operation section 126 calculates the amount of exposure by detecting the brightness of the field based on the generated image data and further detects the contrast of the field that changes as the focus lens 114 moves. Based on the amount of exposure calculated by the AF/AE operation section 126, an appropriate amount of exposure is determined, and the aperture 113 and a timing generator 111a are driven to control the amount of exposure so that the determined amount of exposure is realized. Also, based on the contrast of the field detected by the AF/AE operation section 126, a position where a peak of the contrast is obtained is determined as the above-mentioned focus position, and the focus lens 114 is placed at the focus position by the focus control section 114a.

The digital camera 100 further includes a CCD 111 that receives subject light that forms an image by passing through the image-taking optical system 110, thereby generating an analog image signal representing the subject light. In the CCD 111, the subject light indicated by alternate long and short dashed lines is converted into the analog image signal representing the subject light and outputted from the CCD 111 in accordance with a timing signal of the timing generator 111a which determines a shutter speed.

The analog image signal outputted from the CCD 111 is read by an image-signal processing section 122 where the analog image signal is converted into digital image data and further subjected to various kinds of image processing such as white balance and γ correction (gamma correction). The image data after being subjected to the image processing is sent to a display control section 123 that controls the display of images, and an image (a so-called through image) represented by this image data is displayed on the image display section 130.

The digital camera 100 further includes: a microphone 125 that converts a sound at the time of shooting into an electrical signal; and at least one of a temperature sensor that measures a temperature at the time of shooting and generates an electrical signal representing the temperature, a wind-velocity sensor that measures a wind velocity and generates an electrical signal representing the wind velocity, a humidity sensor that measures a humidity and generates an electrical signal, and an atmospheric-pressure sensor that measures an atmospheric pressure and generates an electrical signal. In FIG. 23, the temperature sensor, the wind-velocity sensor, the humidity sensor and the atmospheric-pressure sensor are collectively indicated as a sensor 124. The electrical signals obtained by the microphone 125 and the sensor 124 also are converted into digital data by the image-signal processing section 122. In the following, the digital data representing environment information such as the sound, temperature, wind velocity, humidity and atmospheric pressure at the time of shooting is referred as environment information data so that this data is clearly distinguished from the digital image data representing the shot image. Further, in this digital camera 100, the shot-image data is subjected to compression processing and the shot-image data after being compressed is transmitted to the personal computer 200 in FIG. 20 via the USB cable 300 in FIG. 20 whose USB terminal is inserted into the USB connector 131. The digital camera 100 includes a writing/reading section 140 that writes and reads data into and from the memory card 141 inserted into the memory card slot 142. The above-mentioned compression processing is executed when an image compression processing program stored in the memory card 141 is read by the writing/reading section 140 thereby being installed on the digital camera 100 so that a CPU 120 functions as a compression processing section. The shot-image data targeted for the compression processing is sent to the CPU 120 that functions as the compression processing section and then subjected to the compression processing. Incidentally, the above-mentioned shot-image data also is sent to the CPU 120 that functions as the compression processing section.

The digital camera 100 includes a ROM 121 that stores execution data indicating an operational procedure to be executed by the CPU 120 that controls each section of the digital camera 100. Here, in FIG. 23, various switches and buttons such as the power switch 104, the mode dial 10 and the release button 150 depicted in FIG. 21 and FIG. 22 are collectively illustrated as an operation section 151. When the operation section 151 is operated, processing corresponding to that operation is executed according to the execution data stored in the ROM 121.

Data is exchanged via a bus 1200 between the CPU 120 and each section such as the image-taking optical system 110, the image-signal processing section 122, the display control section 123 and the writing/reading section 140, and a RAM 129 is provided as a buffer used when the data is exchanged via the bus 1200. Data that serves as a variable according to the progress of a processing process of each section is written into this RAM 129 whenever necessary, and each section such as the image-taking optical system 110 and the image-signal processing section 122 carries out appropriate processing by referring to the data.

Now, operation of the digital camera 100 at the time when a moving-image is taken will be described below.

When the release button 150 illustrated in FIG. 21 is pressed by a photographer in a state in which the operation mode of the digital camera 100 is set to the moving-image shooting mode by the mode dial 10 in FIG. 22, information representing the fact that the release button 150 is pressed is transmitted to the CPU 120. Upon receipt of this information, the CPU 120 issues instructions to the AF/AE operation section 126, the aperture control section 113a, the timing generator 111a and the focus control section 114a, and thereby causes them to execute the control of the amount of exposure and the automatic focus as described above. Subsequently, based on the instruction from the CPU 120, in the image-signal processing section 122, an image signal generated by the CCD 40 is read by more finely than when the above-mentioned through image is read, and the read signal is converted into digital image data so that shot-image data of a high resolution is generated. Further, the generated shot-image data is subjected to various kinds of image processing such as white balance and γ correction in the image-signal processing section 122, and temporarily stored in a buffer memory 143. The shot-image data stored in the buffer memory 143 is supplied to the CPU 120 that functions as the compression processing section and subjected to the compression processing. Meanwhile, in response to the generation of the shot-image data, electrical signals obtained by the microphone 125 and the sensor 124 are converted into digital data by the above-described image-signal processing section 122 so that environment information data is generated. This environment information data also is supplied to the CPU 120 that functions as the compression processing section. Based on the same shot-image data, the CPU 120 that functions as the compression processing section generates two kinds of compressed data: shot-image data after being subjected to reversible compression processing and shot-image data after being subjected to irreversible compression processing. Further, a compression ratio is estimated during processes of these two types of compression processing. When an estimated value of the compression ratio is beyond the above-described first target compression ratio, transmission data formed by adding the environment information data to the shot-image data after being subjected to the irreversible compression processing is transmitted to the personal computer 200. When the estimated value of the compression ratio is equal to or below the first target compression ratio, the shot-image data after being subjected to the reversible compression processing is directly sent to the personal computer 00 in FIG. 1 as transmitted data.

Until the release button 150 illustrated in FIG. 21 is pressed by the photographer once again, the above-described operations are repeated and sequential transmission of the shot-image data to the personal computer 200 in FIG. 20 is maintained.

Incidentally, in the camera system in FIG. 20, the moving-image shooting is mainly performed and thus, the operation of the digital camera 100 at the time of shooting the moving image has been described above. However, as mentioned above, this digital camera 100 has also the function of shooting a still image. The still-image shooting is performed when the release button 150 is pressed by the user in a state in which the operation mode of the digital camera 100 is set to the still-image shooting mode by the mode dial 10 in FIG. 22. In the still-image shooting, image data representing an image (still image) for one frame immediately after the release button 150 is pressed is generated in the same process as that described above and transmitted to the personal computer 200. Incidentally, in the still-image shooting, when a subject is dark, a flash is emitted from the flash emitting section 103 in synchronization with the press of the release button 150, based on the instruction of the CPU 120.

The functional block of the CPU 120 that functions as the compression processing section is approximately the same as that of the compression processing section 500, and the CPU 120 acts as each section of the compression processing section 500 in FIG. 2. However, each of the first compression ratio estimation section 1570 and the second compression ratio estimation section 2570 in the compression processing section 500 illustrated in FIG. 2 is provided with the hardware such as the absolute-value difference device, the pulse-width modulator and the integrator (see FIG. 16) to estimate the compression ratio, whereas in the digital camera 100 illustrated in FIG. 23, the CPU 120 executes operations performed by the absolute-value difference device, the pulse-width modulator and the integrator, which is the only difference. In other words, in the digital camera 100 illustrated in FIG. 23, the CPU 120 subtracts 8 from each numerical value of post-offset data thereby obtaining a difference and determines an absolute value of the difference and further, the CPU 120 performs an operation for determining a sum of the absolute values of the respective differences of all the numerical values thereby calculating the same value as the integral obtained by the integrator 1570d. Otherwise, the function of the CPU 120 serving as the compression processing section is the same as that of the compression processing section 500 in FIG. 2.

FIG. 24 is a schematic block diagram of the image compression processing program equivalent to an embodiment of the data compression program of the present invention.

Here, this program is an image compression processing program 600 and stored in the memory card 141. The image compression processing program 600 includes a first differential encoding section 1610, a first offset section 1620, a first plane division section 1630, a first L-plane compression section 1640, a first H-plane compression section 1650, a first compression ratio estimation section 1670, a thinning processing section 2605, a second differential encoding section 2610, a second offset section 2620, an edge detection section 2625, a second plane division section 2630, a second L-plane compression section 2640, a second H-plane compression section 2650, a FAKE-pixel-data compression section 2660, a second compression-ratio estimation section 2670, a parameter setting section 2680 and an output switching section 601.

When the memory card 141 illustrated in FIG. 24 is inserted into the memory card slot 142 of the digital camera 100 illustrated in FIG. 2 and the program 600 stored in the memory card 141 is installed on the digital camera 100 and executed by the CPU 120, the digital camera 100 operates as an apparatus that performs the processing compression for image data. To be more specific, when each section of the above-described program 600 is read by the writing/reading section 140, expanded by the RAM 129, and executed by the CPU 120, the combination of the CPU 120 and the image-signal processing section 122 functions as the compression processing section 500 in FIG. 2. Here, the first differential encoding section 1610, the first offset section 1620, the first plane division section 1630, the first L-plane compression section 1640, the first H-plane compression section 1650, the first compression ratio estimation section 1670, the thinning processing section 2605, the second differential encoding section 2610, the second offset section 2620, the edge detection section 2625, the second plane division section 2630, the second L-plane compression section 2640, the second H-plane compression section 2650, the FAKE-pixel-data compression section 2660, the second compression-ratio estimation section 2670, the parameter setting section 2680 and the output switching section 601 in the image compression program 600 illustrated in FIG. 24 are program modules that cause the CPU 120 to operate as the first differential encoding section 1510, the first offset section 1520, the first plane division section 1530, the first L-plane compression section 1540, the first H-plane compression section 1550, the first compression-ratio estimation section 1570, the thinning processing section 2505, the second differential encoding section 2510, the second offset section 2520, the edge detection section 2525, the second plane division section 2530, the second L-plane compression section 2540, the second H-plane compression section 2550, the FAKE-pixel-data compression section 2560, the second compression-ratio estimation section 2570, the parameter setting section 2580 and the output switching section 501 in FIG. 2. In other words, by these program modules, the elements of the compression processing section 500 in FIG. 2 are substantially implemented on the digital camera 100.

The operation of each section of the image compression program 600 in FIG. 24 when executed by the CPU 120 is the operation of each corresponding section of the compression processing section 500 in FIG. 2. Therefore, the description of each section of the compression processing section 500 will be omitted.

Up to this point, the present embodiment has been described.

In the above description, the apparatus that performs the compression processing is the digital camera provided with the moving-image shooting function. However, the present invention may be a video camera.

Further, in the above description, when the image data after being subjected to irreversible compression processing is transmitted to the personal computer, the environment information data representing the shooting environment is added to the image data. However, in the present invention, for example, text data in which a memo about the shooting provided by the user is recorded may be added to the image data.

Incidentally, among apparatus each of which forms an image on an imaging element by receiving subject light coming through an image-taking optical system and thereby generates an image signal, there is an apparatus that performs focusing by measuring the contrast of a subject image obtained as a result of image formation on the imaging element while moving a focus lens and by moving the focus lens to a position where the contrast is maximum (see, for example, Japanese Patent Application Publication No. 2003-248165).

Meanwhile, moving images and the like by using an inexpensive small camera called the webcam as mentioned above are frequently transmitted through the Internet. This webcam is usually connected to a personal computer via an interface standard typically provided in the personal computer, such as USB (Universal Serial Bus). The focusing in the webcam is carried out in such a way that an image taken by an imaging element while the position of a focus lens is changed in the webcam is transmitted to the personal computer that in turn performs an analysis of the contrast and the like of the taken image and the result of the analysis is transmitted to the webcam.

Therefore, there is such a problem that it takes a long time to perform the focusing in the webcam because of frequent data transmission to and from the personal computer.

In view of this problem, it is conceivable to perform the focusing in a phase-difference detection method that is a so-called passive method.

However, the adoption of the focusing in such a method requires an AF sensor dedicated to the focusing, which is a problem in terms of cost although the focusing may become speedy.

In view of the foregoing situation, there will be described below an image-taking apparatus in which swift focusing and prevention of a cost increase are mutually compatible.

In the following, a second embodiment of the present invention will be described.

FIG. 25 is a schematic diagram of a camera system to which the second embodiment is applied.

A camera system 3001 illustrated in FIG. 25 includes a USB camera 3002, a USB cable 3003 and a personal computer 3004.

The USB camera 3002 is an autofocus camera having about three million (3 MB) pixels and its frame rate is 30 frames per second. The USB camera 3002 has a function of compressing image data and transmitting the compressed image data. The USB camera 3002 is an embodiment of the image-taking apparatus of the present invention.

The USB cable 3003 is based on the standard 2.0 and its maximum transfer rate is 480 Mbps.

The personal computer 3004 has a function of receiving the compressed image data sent from the USB camera 2 via the USB cable 3 and decompresses the received compressed image data.

Further, although the USB camera 3002 requires the USB cable 3003 to have a transfer rate equal to or more than 720 Mbps, the USB camera 3002 has the function of compressing the image data and thus is capable of transmitting the image data via the USB cable 3003 whose maximum transfer rate is 480 Mbps.

Further, as mentioned above, the USB camera 3002 is the autofocus camera and has the function of compressing the image data and transmitting the compressed image data, and the focusing is performed by using the image data in a data compression process.

FIG. 26 is an internal block diagram of the USB camera.

The USB camera 3002 illustrated in FIG. 26 includes an image-taking section 3020, a differential encoding section 1510, an offset section 1520, a plane division section 1530, an L-plane compression section 1540, an H-plane compression section 1550, a monitoring section 3028 and a position adjustment section 3021. Incidentally, among elements illustrated in FIG. 26, elements equivalent to those illustrated in FIG. 2 are indicated by the same reference characters as those in FIG. 2.

The image-taking section 3020 includes: an objective lens 3201 fixed on an optical axis of the image-taking section 3020; a focus lens 3202 that performs focusing by moving along the optical axis; a CCD 3203 in which an image is formed based on subject light coming through these lenses; and a bitmap generation circuit 3204.

The bitmap generation circuit 3204 subjects image processing such as sampling hold and gain adjustment to an analog signal for each color (R color, G color and B color) outputted by the CCD 3203 and then converts each of these signals into a digital signal by an A/D converter not illustrated and outputs the digital signal. Also, a BAYER image in accordance with the array of the CCD may be directly outputted.

In the differential encoding section 1510, the bitmapped image data is subjected to two-dimensional differential encoding processing, namely, processing that determines, for a series of numerical values of the input image data, a two-dimensional difference between a numerical value and a numerical value adjacent to the numerical value in each of plural directions when viewing the image, thereby generating image data made up of a series of 8-bit numerical values each representing the difference.

In the offset section 1520, the image data generated in the differential encoding section 1510 and made up of the numerical values each representing the difference is offset by an offset value “8.”

The monitoring section 3028 replaces a feature amount of the data from the offset section 1520 with a voltage for focusing and outputs the voltage.

The position adjustment section 3021 performs the focusing by moving the focus lens 3202 to a position where a local maximum value of an electricity value, which will be described later in detail, from the monitoring section 3028 is obtained while the focus lens 3202 is moved.

The plane division section 1530 divides each of numerical values of the image data after being offset into lower-order 4 bits and higher-order 4 bits, thereby dividing the image data into a lower-order sub-plane D1L formed by a series of lower-order numerical values and a higher-order sub-plane D1H formed by a series of higher-order numerical values.

In the L-plane compression section 1540 and the H-plane compression section 1550, the lower-order sub-plane D1L and the higher-order sub-plane D1H obtained as a result of the division by the plane division section 153 are subjected to reversible compression.

A set of the lower-order sub-plane D2L and the higher-order sub-plane D2H respectively output from the L-plane compression section 1540 and the H-plane compression section 1550 forms compressed data with respect to the original image data. This compressed data is transmitted to a compressed-data decompression processing circuit, not illustrated, of the personal computer 3004 via the USB cable 3003 illustrated in FIG. 25, and subjected to data decompression processing. In this data decompression processing, decoding processing corresponding to the various kinds of encoding processing described above with reference to FIG. 3 is applied and image data identical to the original image data is obtained.

Now, the focusing function of the USB camera 3002 will be described below in detail.

FIG. 27 is an internal block diagram of the monitoring section illustrated in FIG. 26.

The monitoring section 3028 illustrated in FIG. 27 includes an absolute-value difference device 3281, a PWM (Pulse Width Modulation) 3282 and an integrator 3283.

In the absolute-value difference device 3281, a difference between a reference value “8” and the data from the offset section 3024 is detected.

In the PWM 3282, there is generated a pulse having a width according to the difference obtained by the absolute-value difference device 281.

The integrator 3283 integrates the widths of the pulses generated by the PWM 3282 at every predetermined time interval thereby obtaining an integral, and then replaces the integral with a voltage and outputs the voltage.

FIG. 8 and FIG. 29 illustrate histograms of the image data inputted into the monitoring section at the time of complete off-focus and at the time of on-focus, respectively, by way of examples.

FIG. 28 and FIG. 29 illustrate the histograms obtained when pieces of image data acquired by shooting images of a predetermined subject at the time of complete off-focus and at the time of on-focus, respectively, are subjected to differential encoding and further offset based on the offset value “8”. The horizontal axis indicates data values from 1 to 256 whereas the vertical axis indicates frequencies of occurrence of pixels having the respective data values.

What can be read from FIG. 28 and FIG. 29 is that no sharp peak appears for any of the data values in the image data obtained by the shooting in the complete off-focus, whereas the image data obtained by the shooting in the on-focus has a sharp peak at a data value “8” that is the same as the offset value and frequencies of occurrence of pixels having data values of “16” or more are almost “0”.

FIG. 30 is a graph that illustrates a relationship between the voltage output from the monitoring section and the position of the focus lens on the optical axis when an image of a predetermined subject is shot by moving the focus lens.

This is an example in which the histogram is broad in the off-focus. Generally, at the time of off-focus, such a broad state occurs because of the influence of a noise due to a decrease in the density of the amount of light toward the sensor. Conversely, for example, when there is a sufficient light amount, it is conceivable that the histogram may have a sharp peak in the off-focus. In this case as well, a P2 (an inflection point) in FIG. 30 is present and thus, it is possible to detect the best-focus point in a manner similar to the general case.

FIG. 30 illustrates a case in which the positions of the focus lens 3202 on the optical axis and the voltages generated by the integrator 3283 of the monitoring section 3028 at the time when the focus lens is moved while the objective lens 3201 is kept directed to the predetermined subject are plotted while being made to correspond to each other. What is illustrated here is a state where each of the voltage values at positions P1 and P3, which are slightly off-focus positions as compared to the focus position P2 and have the position P2 in between, is a minimum value A1, whereas the voltage value at the focus position P2 is a maximum value A2. This is because the image is blurry at the positions P1 and P3 because the focus is slightly off at these positions and thus the differences each between adjacent numerical values concentrate on “0” or “255”, namely the histogram becomes sharp, whereas the image is clear at the position P2 because the focus is on at this position and thus the differences each between adjacent numerical values are larger than those at the positions P1 and P3, which weakens the concentration of the differences on “0” or “255”, namely the histogram becomes broad. Incidentally, in a range out of the range from the position P1 to the position P3, namely in the complete off-focus, a noise component becomes large and the histogram becomes broad as illustrated in FIG. 28 and therefore, concentration on the difference “0” or “255” weakens.

The position adjustment section 3021 illustrated in FIG. 26 stops the focus lens 3202 at the above-described position where the local maximum value is obtained, for the electricity value from the monitoring section 3028, while the focus lens 3202 is moved. In other words, in the camera 3002, when the focus lens 3202 is present at the focus position, the focusing is performed by using the fact that the electricity has a maximum value locally as described above. That is to say, in the USB camera 3002 of the present embodiment, since a simple operation method, which is to obtain the difference, is adopted, it is possible to perform successive processing by the simple circuit configuration as illustrated in FIG. 26 and FIG. 27. For this reason, it is possible to carry out the focusing in real time without stopping the data stream. Therefore, according to the USB camera 3002 of the present embodiment, swift focusing and prevention of a cost increase can be mutually compatible. Incidentally, when the local maximum value goes beyond a threshold by changing, the position adjustment section 3021 assumes that a change has occurred in the subject and moves the focus lens 3202 again.

The compression of the image data in this USB camera 3002 is performed by the differential encoding section 1510, the offset section 1520, the plane division section 1530, the L-plane compression section 1540 and the H-plane compression section 1550 illustrated in FIG. 26. However, the operations of these elements are similar to those described above with reference to FIG. 2 through FIG. 14 and thus, the description of these elements will be omitted to avoid overlaps.

1. A data compression apparatus, comprising:
a differential generation section that determines, for a series of numerical values of to-be-compressed data made up of a series of numerical values, a difference between numerical values adjacent to each other directly or with a given space therebetween, so as to generate new to-be-compressed data made up of a series of numerical values each representing the difference;
a compression section that subjects the new to-be-compressed data generated by the differential generation section to compression processing; and
an estimation section that determines a concentration degree indicating concentration of respective numerical values of the new to-be-compressed data generated by the differential generation section on a numerical value representing a difference “0”, and estimates a compression degree used when the new to-be-compressed data is compressed by the compression section, such that the higher the concentration degree is, the higher the compression degree is.

2. The data compression apparatus according to claim 1, wherein
the compression section has a plurality of compression processing sections that perform compression processing in methods different from each other,
the estimation section estimates a compression degree in at least one of the plurality of compression processing sections, and
the data compression apparatus further comprises a selection section that selects a compression processing section according to the compression degree estimated by the estimation section from among the plurality of compression processing sections, and causes the compression section to output compressed data obtained by the selected compression processing section as output data.

3. The data compression apparatus according to claim 1, wherein
the compression section has a compression parameter set therein to adjust the compression degree and performs compression processing according to the compression parameter, and
the data compression apparatus further comprises a compression parameter setting section that sets the compression parameter in the compression section according to the compression degree estimated by the estimation section.

4. The data compression apparatus according to claim 1, wherein, for numerical values of to-be-compressed data which represents a two-dimensional image by a series of numerical values, a two-dimensional difference between numerical values adjacent to each other directly or with a given space therebetween is determined.

5. The data compression apparatus according to claim 1, wherein
the differential generation section generates, as the new to-be-compressed data, to-be-compressed data made up of a series of numerical values in which the difference is represented by a predetermined unit bit number,
the compression section includes:
an offset section that offsets each numerical value of the new to-be-compressed data generated by the differential generation section by a predetermined value;
a division section that divides each of numerical values of the to-be-compressed data having the numerical value offset by the offset section into a higher-order bit portion and a lower-order bit portion, at a predetermined division bit number smaller than the predetermined unit bit number, thereby dividing the to-be-compressed data into higher-order data made up of a series of the higher-order bit portions of the respective numerical values and lower-order data made up of a series of the higher-order bit portions of the respective numerical values;
a lower-order-data compression section that subjects the lower-order data obtained as a result of division by the division section to reversible compression processing; and
a higher-order-data compression section that subjects the higher-order data obtained as a result of the division by the division section to reversible compression processing, and
the estimation section determines a concentration degree indicating concentration of respective numerical values of the to-be-compressed data having the numerical value offset by the offset section on the predetermined value, and estimates the compression degree such that the higher the concentration degree is, the higher the compression degree is.

6. The data compression apparatus according to claim 5, wherein the higher-order-data compression section includes a first encoding section that directly outputs numerical values except one or a plurality of predetermined to-be-compressed numerical values in the higher-order data, and outputs the to-be-compressed numerical values through encoding the to-be-compressed numerical values into the to-be-compressed numerical values and numerical values representing the consecutive number of the to-be-compressed numerical values identical to the to-be-compressed numerical value.

7. The data compression apparatus according to claim 5, wherein
the higher-order-data compression section includes:
a first encoding section that directly outputs numerical values except one or a plurality of predetermined to-be-compressed numerical values in the higher-order data, and outputs the to-be-compressed numerical values by encoding the to-be-compressed numerical values into a to-be-compressed numerical value and into a numerical value representing the number of consecutive to-be-compressed numerical values each identical to the to-be-compressed numerical value; and
a second encoding section that subjects the data after being encoded by the first encoding section to entropy coding by using a table that associates codes with numerical values.

8. The data compression apparatus according to claim 5, wherein
the higher-order-data compression section includes:
a first encoding section that directly outputs numerical values except one or a plurality of predetermined to-be-compressed numerical values in the higher-order data, and outputs the to-be-compressed numerical values by encoding the to-be-compressed numerical values into a to-be-compressed numerical value and into a numerical value representing the number of consecutive to-be-compressed numerical values each identical to the to-be-compressed numerical value; and
a second encoding section that subjects the data after being encoded by the first encoding section to Huffman encoding by using a Huffman table.

9. The data compression apparatus according to claim 5, wherein
the higher-order-data compression section includes:
a first encoding section that directly outputs numerical values except one or a plurality of predetermined to-be-compressed numerical values in the higher-order data, and outputs the to-be-compressed numerical values by encoding the to-be-compressed numerical values into a to-be-compressed numerical value and into a numerical value representing the number of consecutive to-be-compressed numerical values identical to the to-be-compressed numerical value;
a histogram calculation section that determines a histogram of numerical values which appear in the data after being encoded by the first encoding section;
a code assignment section that assigns, based on the histogram determined by the histogram calculation section, codes to numerical values such that a code having a shorter code length is assigned to a numerical value of a higher frequency of occurrence, in a table associating codes with numerical values; and
a second encoding section that subjects the data after being encoded by the first encoding section to entropy coding by using the table in which the codes are assigned by the code assignment section.

10. The data compression apparatus according to claim 5, wherein the lower-order-data compression section subjects the lower-order data to entropy coding by using a table associating codes with numerical values.

11. The data compression apparatus according to claim 5, wherein the lower-order-data compression section subjects the lower-order data to Huffman encoding by using a Huffman table.

12. The data compression apparatus according to claim 5, wherein the lower-order-data compression section outputs the lower-order data without performing compression upon receipt of an instruction of compression omission.

13. A computer-readable storage medium storing a data compression program incorporated in an information processing apparatus that executes a program and causing the information processing apparatus to execute data compression processing, the data compression program implementing, in the information processing apparatus:
a differential generation section that determines, for a series of numerical values of to-be-compressed data made up of a series of numerical values, a difference between numerical values adjacent to each other directly or with a given space therebetween, so as to generate new to-be-compressed data made up of a series of numerical values each representing the difference;
a compression section that subjects the new to-be-compressed data generated by the differential generation section to compression processing; and
an estimation section that determines a concentration degree indicating concentration of respective numerical values of the new to-be-compressed data generated by the differential generation section on a numerical value representing a difference “0”, and estimates a compression degree used when the compressed data is compressed by the compression section, such that the higher the concentration degree is, the higher the compression degree is.

14. An image-taking apparatus, comprising:
an image-data generation section that generates image data made up of a series of numerical values representing an image of a subject, by taking the image of the subject;
a reversible compression section that subjects the image data generated by the mage-data generation section to reversible compression processing; a irreversible compression section that subjects the image data generated by the mage-data generation section to irreversible compression processing; and
a selection transmission section that selectively transmits, to a predetermined data-receiving device, one of the image data after being subjected to the reversible compression processing by the reversible compression section and the image data after being subjected to the irreversible compression processing by the irreversible compression section, wherein
the reversible compression section includes a first estimation section that estimates a compression degree used by the reversible compression section,
the irreversible compression section includes:
a thinning processing section that takes out numerical values from a series of numerical values of the image data generated by the image-data generation section thereby creating first image data made up of a series of the numerical values taken out and second image data made up of a series of remaining numerical values;
a first compression section that subjects the first image data to reversible compression processing;
a second compression section that subjects the second image data to irreversible compression processing according to a set compression parameter;
a second estimation section that estimates a compression degree used by the irreversible compression section; and
a compression parameter setting section that sets a compression parameter in the second compression section according to an estimated value obtained by the second estimation section, so as to keep the compression degree used by the irreversible compression section higher than a predetermined second compression degree that is higher than a predetermined first compression degree so determined as to fit image data in a limit of an amount of data transmitted by the selection transmission section, and
the selection transmission section transmits compressed data obtained by the reversible compression section when an estimated value obtained by the first estimation section is higher than the first compression degree, and transmits compressed data obtained by the irreversible compression section when the estimated value is low.

15. The image-taking apparatus according to claim 14, further comprising:
an environment information obtaining section that obtains, as the image-taking environmental data, image-taking environmental data representing at least one of pieces of information representing a sound, a wind velocity, a temperature, a humidity and an atmospheric pressure in an image-taking environment; and
an environment information adding section that adds the image-taking environmental data obtained by the environment information obtaining section to the image data compressed by the irreversible compression section,
wherein the second compression degree is set to fit a sum of the image data and the image-taking environmental data in the limit of the amount of data transmitted by the selection transmission section.

16. The image-taking apparatus according to claim 14, wherein
the reversible compression section includes:
a first differential generation section that determines a difference between numerical values adjacent to each other, for a series of numerical values of image data generated by the image-data generation section, so as to generate new image data made up of a series of numerical values each representing the difference; and
a compression processing section that subjects the image data generated by the first differential generation section to reversible compression processing,
the first estimation section determines a concentration degree indicating concentration of respective numerical values of the image data generated by the first differential generation section on a numerical value representing a difference “0”, and estimates a compression degree used when the image data is compressed by the compression processing section, such that the higher the concentration degree is, the higher the compression degree is,
the first compression section includes a second differential generation section that determines a difference between numerical values adjacent to each other, for a series of numerical values of first image data, thereby generating new image data made up of a series of numerical values each representing the difference, and the first compression section subjects the image data generated by the second differential generation section to irreversible compression processing, and
the second estimation section determines a concentration degree indicating concentration of respective numerical values of the image data generated by the second differential generation section on a numerical value representing a difference “0”, and estimates a compression degree used when the image data is compressed by the irreversible compression section, such that the higher the concentration degree is, the higher the compression degree is.

17. The image-taking apparatus according to claim 16, wherein at least one of the first differential generation section and the second differential generation section determines a two-dimensional difference between a numerical value of image data targeted for a difference and a numerical value adjacent to the numerical value in each of a plurality of directions when viewed on the image.

18. The image-taking apparatus according to claim 17, wherein
the image-data generation section generates, as the image data, image data made up of a series of numerical values represented by a predetermined unit bit number,
the second compression section includes:
a determination section in which a determination criterion is set and which determines an edge portion in the image based on the determination criterion; and
a data conversion section that outputs a predetermined code in a bit number smaller than the predetermined unit bit number, when a numerical value of the second image data created by the thinning processing section is not an edge portion, and re-expresses the numerical value in a bit number smaller than the predetermined unit bit number and larger than the bit number of the predetermined code so as to output the re-expressed numerical value, when the numerical value is an edge portion, and
the compression parameter setting section sets a severer determination criterion for a larger compression degree estimated by the second estimation section, so as to reduce an image portion assumed to be the edge portion.

19. The image-taking apparatus according to claim 18, wherein the data conversion section cuts off lower digits of a bit value in the predetermined unit bit number, when re-expressing the numerical value in the bit number smaller than the predetermined unit bit number and larger than the bit number of the predetermined code.

20. The image-taking apparatus according to claim 16, wherein
the first differential generation section generates, as the image data, image data made up of a series of numerical values in which the difference is represented by a predetermined bit number,
the compression processing section includes:
a first offset section that offsets each numerical value of the new image data generated by the first differential generation section by a predetermined value;
a first division section that divides each of numerical values of the image data having the numerical value offset by the first offset section into a higher-order bit portion and a lower-order bit portion, at a predetermined division bit number smaller than the predetermined unit bit number, so as to divide the image data into higher-order data made up of a series of the higher-order bit portions of the respective numerical values and lower-order data made up of a series of the higher-order bit portions of the respective numerical values;
a first lower-order-data compression section that subjects the lower-order data obtained as a result of division by the first division section to reversible compression processing; and
a first higher-order-data compression section that subjects the higher-order data obtained as a result of division by the first division section to reversible compression processing,
the first compression section includes:
a second offset section that offsets each numerical value of the new image data generated by the second differential generation section by a predetermined value;
a second division section that divides each of numerical values of the image data having the numerical value offset by the second offset section into a higher-order bit portion and a lower-order bit portion, at a predetermined division bit number smaller than the predetermined unit bit number, so as to divide the image data into higher-order data made up of a series of the higher-order bit portions of the respective numerical values and lower-order data made up of a series of the higher-order bit portions of the respective numerical values;
a second lower-order-data compression section that subjects the lower-order data obtained as a result of division by the second division section to reversible compression processing; and
a second higher-order-data compression section that subjects the higher-order data obtained as a result of the division by the second division section to reversible compression processing,
the first estimation section determines a concentration degree indicating concentration of respective numerical values of the image data having the numerical value offset by the first offset section on the predetermined value, so as to estimate the compression degree used by the reversible compression processing section, and
the second estimation section determines a concentration degree indicating concentration of respective numerical values of the image data having the numerical value offset by the second offset section on the predetermined value, so as to estimate the compression degree used by the irreversible compression processing section.

21. The image-taking apparatus according to claim 20,
wherein at least one of the first higher-order-data compression section and the second higher-order-data compression section directly outputs numerical values except one or a plurality of predetermined to-be-compressed numerical values in the higher-order data, and outputs the to-be-compressed numerical values by encoding the to-be-compressed numerical values into a to-be-compressed numerical value and into a numerical value representing the number of consecutive to-be-compressed numerical values identical to the to-be-compressed numerical value.

22. The image-taking apparatus according to claim 20, further comprising:
a first encoding section in which at least one of the first higher-order-data compression section and the second higher-order-data compression section directly outputs numerical values except one or a plurality of predetermined to-be-compressed numerical values in the higher-order data, and outputs the to-be-compressed numerical values by encoding the to-be-compressed numerical values into a to-be-compressed numerical value and into a numerical value representing the number of consecutive to-be-compressed numerical values each identical to the to-be-compressed numerical value; and
a second encoding section that subjects data after being encoded by the first encoding section to entropy coding by using a table that associates codes with numerical values.

23. The image-taking apparatus according to claim 20, further comprising:
a first encoding section in which at least one of the first higher-order-data compression section and the second higher-order-data compression section directly outputs numerical values except one or a plurality of predetermined to-be-compressed numerical values in the higher-order data, and outputs the to-be-compressed numerical values by encoding the to-be-compressed numerical values into a to-be-compressed numerical value and into a numerical value representing the number of consecutive to-be-compressed numerical values each identical to the to-be-compressed numerical value; and
a second encoding section that subjects data after being encoded by the first encoding section to Huffman encoding by using a Huffman table.

24. The image-taking apparatus according to claim 20, further comprising:
a first encoding section in which at least one of the first higher-order-data compression section and the second higher-order-data compression section directly outputs numerical values except one or a plurality of predetermined to-be-compressed numerical values in the higher-order data, and outputs the to-be-compressed numerical values by encoding the to-be-compressed numerical values into a to-be-compressed numerical value and into a numerical value representing the number of consecutive to-be-compressed numerical values each identical to the to-be-compressed numerical value;
a histogram estimation section that determines a histogram of numerical values which appear in data after being encoded by the first encoding section;
a code assignment section that assigns, based on the histogram determined by the histogram estimation section, codes to numerical values such that a code having a shorter code length is assigned to a numerical value of a higher frequency of occurrence, in a table associating codes with numerical values; and
a second encoding section that subjects the data after being encoded by the first encoding section to entropy coding by using the table in which the codes are assigned by the code assignment section.

25. The image-taking apparatus according to claim 20, wherein at least one of the first lower-order-data compression section and the second lower-order-data compression section subjects entropy coding to the lower-order data by using a table associating codes with numerical values.

26. The image-taking apparatus according to claim 20, wherein at least one of the first lower-order-data compression section and the second lower-order-data compression section subjects Huffman encoding to the lower-order data by using a Huffman table.

27. The image-taking apparatus according to claim 20, wherein at least one of the first lower-order-data compression section and the second lower-order-data compression section outputs the lower-order data without performing compression upon receipt of an instruction of compression omission.

28. An image-taking apparatus, comprising:
an image-taking optical system that forms an image by receiving light from a subject and is capable of adjusting an image-formation position;
an imaging section that captures the image formed by the image-taking optical system, so as to output image data that expresses the image by a group of pixels and is made up of a series of pixel values of the respective pixels;
a differential generation section that determines a difference between numerical values adjacent to each other, for a series of pixel values of the image data outputted by the imaging section, so as to generate differential data made up of a series of numerical values each representing the difference;
a concentration-degree measuring section that measures a concentration degree indicating concentration of respective numerical values of the differential data generated by the differential generation section on a numerical value representing a difference “0”; and
an image-formation-position adjustment section that checks the concentration degree measured by the concentration-degree measuring section while adjusting the image-formation position of the image-taking optical system, so as to direct the image-formation position of the image-taking optical system toward an image-formation position that indicates the concentration degree being a local minimum.

29. The image-taking apparatus according to claim 28, further comprising:
an offset section that offsets each numerical value of the differential data generated by the differential generation section by a predetermined value, wherein
the concentration-degree measuring section measures a concentration degree indicating concentration of the respective numerical values offset by the offset section on a numerical value identical to the predetermined value, so as to indirectly measure the concentration degree indicating the concentration of the numerical values of the differential data generated by the differential generation section on the numerical value representing the difference “0”.

30. The image-taking apparatus according to claim 28, further comprising:
an offset section that offsets each of numerical values of the differential data generated by the differential generation section by a predetermined value, wherein
the concentration-degree measuring section includes a voltage-signal generator that outputs a voltage signal of a voltage value according to an absolute value of a difference between each of the numerical values offset by the offset section and the predetermined value, and an integrator that integrates the voltage signal outputted by the voltage-signal generator.

31. The image-taking apparatus according to claim 28, wherein
the differential generation section generates the differential data as new image data made up of a series of numerical values each representing the difference in a predetermined unit bit number,
the image-taking apparatus further comprises an offset section that offsets each of numerical values of the image data generated by the differential generation section by a predetermined value,
the concentration-degree measuring section measures a concentration degree indicating concentration of the respective numerical values offset by the offset section on a numerical value identical to the predetermined value, so as to indirectly measure the concentration degree indicating the concentration of the numerical values of the image data generated by the differential generation section on the numerical value representing the difference “0”, and
the image-taking apparatus further comprises:
a division section that divides each of numerical values of the image data having the numerical value offset by the offset section into a higher-order bit portion and a lower-order bit portion, at a predetermined division bit number smaller than the predetermined unit bit number, thereby dividing the image data into higher-order data made up of a series of the higher-order bit portions of the respective numerical values and lower-order data made up of a series of the higher-order bit portions of the respective numerical values;
a lower-order-data compression section that subjects the lower-order data obtained as a result of division by the division section to reversible compression processing; and
a higher-order-data compression section that subjects the higher-order data obtained as a result of the division by the division section to reversible compression processing.
